(19) United States
(12) Patent Application Publication
(10) Pub. No.: US 2026/0202724 A1
(43) Pub. Date: Jul. 16, 2026

(54) PROJECTION DEVICE AND ELECTRONIC DEVICE INCLUDING SAME

(71) Applicant: LG INNOTEK CO., LTD., Seoul (KR)

(72) Inventor: Ji Sung KIM, Seoul (KR)

(73) Assignee: LG INNOTEK CO., LTD., Seoul (KR)

(21) Appl. No.: 19/137,001

(22) PCT Filed: Dec. 19, 2023
(86) PCT No.: PCT/KR2023/020952

§ 371 Date: Jun. 9, 2025

(30) Foreign Application Priority Data
Dec. 21, 2022 (KR) 10-2022-0180730
May 10, 2023 (KR) 10-2023-0060440

(51) Int. Cl. G03B 21/20; G02B 27/01; G03B 21/28

(52) U.S. Cl. CPC G03B 21/2013; G02B 27/0172; G03B 21/28; G02B 2027/015; G02B 2027/0178

(57) ABSTRACT

An embodiment discloses a projection device comprising: a light guide; a first light source disposed on a first side of the light guide; a lens group disposed on a fourth side of the light guide; and a first side lens disposed between the first side of the light guide and the first light source, wherein the lens group includes first to N^{th} lenses sequentially disposed along the optical axis direction of the lens group, and the first lens is disposed furthest from the fourth side of the light guide, and the first lens and the N−1^{th} lens are aspherical.

### CROSS REFERENCE TO RELATED APPLICATIONS

This application is the National Phase of PCT International Application No. PCT/KR2023/020952, filed on Dec. 19, 2023, which claims priority under 35 U.S.C. 119(a) to Patent Application Nos. 10-2022-0180730, filed on Dec. 21, 2022, and 10-2023-0060440, filed on May 10, 2023, all filed in the Republic of Korea, respectively, all of which are hereby expressly incorporated by reference into the present application.

### TECHNICAL FIELD

Embodiments relate to a projection device and an electronic device including the same.

### BACKGROUND ART

“Virtual reality (VR)” refers to a special environment or situation which is generated by artificial technologies using computers or the like and is similar but not exactly equal to the real world, or to the technologies themselves.

Augmented reality (AR) is a technology for synthesizing a virtual object or virtual information with a real environment such that the virtual object or virtual information looks like a real object or real information that is present in the real environment.

Mixed reality (MR) or hybrid reality is a technology for combining the virtual world and the real world to generate a new environment or new information. In particular, MR is an experience in which real and virtual objects interact with each other in real time.

In this case, the generated virtual environment or situation stimulates the five senses of a user and allows the user to have spatial and temporal experiences similar to reality to freely cross the boundary between reality and imagination. In addition, the user may not only simply be immersed in such an environment but may also interact with objects implemented in the environment by manipulating a real device or giving an instruction.

Recently, research on gear and devices used in these technical fields has been actively underway. However, there is a growing need to miniaturize these devices and improve optical performance.

### DISCLOSURE

### Technical Problem

Embodiments provide a projection device and an electronic device in which, in using a projection device used for augmented reality (AR) and an electronic device including the same, a lens is joined to a surface of a light guide, from which light is emitted, to prevent the occurrence of total reflection on an outer surface of the light guide (for example, a prism), thereby removing stray light.

In addition, embodiments provide a projection device in which a total track length (TTL) is decreased, and an electronic device.

Objects to be solved in the embodiments are not limited thereto, and the embodiments may also include objects or effects that can be understood from the solution or embodiment of the problem described below.

### Technical Solution

A projection device according to an embodiment includes a light guide, a first light source disposed at a first side of the light guide, a lens group disposed at a fourth side of the light guide, and a first side lens disposed between the first side of the light guide and the first light source, wherein the lens group includes first to N^{th} lenses sequentially disposed in an optical axis direction of the lens group, the first lens is positioned farthest from the fourth side of the light guide, and the first lens and an N−1 lens are aspherical.

The projection device may include a second light source disposed at a second side of the light guide, a third light source disposed at a third side of the light guide, a second side lens disposed between the second side of the light guide and the second light source, and a third side lens disposed between the third side of the light guide and the third light source.

The second side and the third side may face each other, and the first side and the fourth side may face each other.

The first side lens, the second side lens, the third side lens, and the N^{th} lens may be in contact with the light guide.

At least one surface of each of the first side lens, the second side lens, the third side lens, and the N^{th} lens may be flat.

A projection side surface or an image side surface of the first lens may be convex toward a projection side.

Optical axes of the first side lens, the second side lens, the third side lens, and the N^{th} lens may be orthogonal to each other.

A total track length (TTL) from the first lens to the light source may be smaller than or equal to twice a focal length of an optical system including the lens group, the light guide, and the first side lens.

A minimum length of the light guide may be greater than a minimum length of the first light source.

The first side of the light guide may overlap the fourth side of the light guide in the optical axis direction of the lens group.

The projection device may include a filter disposed between the first side lens and the first light source.

### Advantageous Effects

Embodiments implement a projection device and an electronic device in which, in using a projection device used for augmented reality (AR) and an electronic device including the same, a lens is joined to a surface of a light guide, from which light is emitted, to prevent the occurrence of total reflection on an outer surface of the light guide (for example, a prism), thereby removing stray light.

In addition, it is possible to implement a projection device in which a total track length (TTL) is decreased, and an electronic device.

In addition, it is possible to implement a projection device and an electronic device in which flare occurrence can be minimized, and a light source can be easily miniaturized.

The various advantageous advantages and effects of the present invention are not limited to the above-described content, and may be more readily understood in the course of describing a specific embodiment of the present invention.

### DESCRIPTION OF DRAWINGS

FIG. 1 is a conceptual view illustrating artificial intelligence (AI) devices according to an embodiment.

FIG. 2 is a block diagram illustrating a configuration of an electronic device for extended reality according to an embodiment of the present invention.

FIG. 3 is a perspective view of an electronic device for augmented reality according to an embodiment of the present invention.

FIGS. 4 to 6 show conceptual views for describing various display methods applicable to a display unit according to an embodiment of the present invention.

FIG. 7 is a perspective view of a projection device according to one embodiment.

FIG. 8 is an exploded perspective view of the projection device according to one embodiment.

FIG. 9 is a view for describing an outer lens, a first spacer, a light guide, a lens, and a second spacer that are coupled to a barrel in a projection device according to one embodiment.

FIG. 10 is a view for describing coupling between the barrel, a housing, and an additional housing in the projection device according to one embodiment.

FIG. 11 is a view for describing coupling between the housing and a light source unit in the projection device according to one embodiment.

FIG. 12 is a view of an optical system of a projection device according to a first embodiment.

FIG. 13 is a perspective view of a light guide, a fourth lens, and a side lens in the projection device according to the embodiment.

FIG. 14 is a view of an optical system of a projection device according to a second embodiment.

### MODES OF THE INVENTION

Hereinafter, exemplary embodiments of the present invention will be described with reference to the accompanying drawings.

However, the technical spirit of the present invention is not limited to the few embodiments which will be described and may be realized using various other embodiments, and at least one component of the embodiments may be selectively coupled, substituted, and used to realize the technical spirit within the range of the technical spirit of the present invention.

In addition, unless clearly and specifically defined otherwise by context, all terms (including technical and scientific terms) used herein may be interpreted as having customary meanings to those skilled in the art, and meanings of generally used terms, such as those defined in commonly used dictionaries, will be interpreted by considering contextual meanings of the related technology.

In addition, the terms used in the embodiments of the present invention are for the purpose of describing the embodiments and are not intended to limit the present invention.

In the present specification, unless clearly indicated otherwise by the context, singular forms include the plural forms thereof, and in a case in which “at least one (or one or more) among A, B, and C” is described, this may include at least one combination among all combinations which may be combined with A, B, and C.

In addition, in descriptions of components of the present invention, terms such as “first,” “second,” “A,” “B,” “(a),” and “(b)” may be used.

The terms are only to distinguish one element from another element, and an essence, order, and the like of the element are not limited by the terms.

In addition, it should be understood that, when an element is referred to as being “connected or coupled” to another element, such a description may include both of a case in which the element is directly connected or coupled to the other element and a case in which the element is connected or coupled to the other element with still another element disposed therebetween.

In addition, in a case in which any one element is described as being formed or disposed “on or below” another element, such a description includes both cases in which the two elements are formed or disposed in direct contact with each other and in which one or more other elements are interposed between the two elements. In addition, when one element is described as being disposed “on or under” another element, such a description may include a case in which the one element is disposed at an upper side or a lower side with respect to the other element.

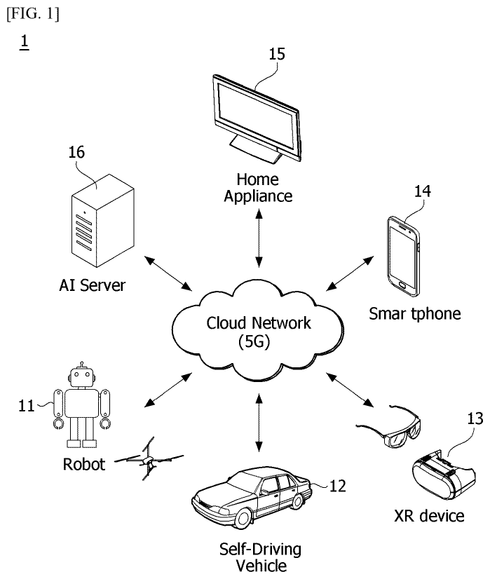

FIG. 1 is a conceptual view illustrating artificial intelligence (AI) devices according to an embodiment.

Referring to FIG. 1, in an AI system, at least one of an AI server 16, a robot 11, a self-driving vehicle 12, an extended reality (XR) device 13, a smartphone 14, and a home appliance 15 is connected to a cloud network 10. Here, the robot 11, the self-driving vehicle 12, the XR device 13, the smartphone 14, and the home appliance 15, to which an AI technology is applied, may be referred to as AI devices 11 to 15.

The cloud network 10 may be a network that constitutes a part of a cloud computing infrastructure or is present inside the cloud computing infrastructure. Here, the cloud network 10 may be constructed using a 3G network, a 4G or Long Term Evolution (LTE) network, or a 5G network.

That is, the devices 11 to 16 constituting the AI system may be connected to each other through the cloud network 10. In particular, the devices 11 to 16 may communicate with each other through a base station, but may also directly communicate with each other without going through the base station.

The AI server 16 may include a server that performs AI processing and a server that performs an operation on big data.

The AI server 16 may be connected to at least one of the AI devices constituting the AI system, such as the robot 11, the self-driving vehicle 12, the XR device 13, the smartphone 14, and the home appliance 15, through the cloud network 10, and may assist with at least a portion of AI processing of the connected AI devices 11 to 15.

In this case, the AI server 16 may train an artificial neural network according to a machine learning algorithm on behalf of the AI devices 11 to 15 and may directly store a learning model or transmit the learning model to the AI devices 11 to 15.

In this case, the AI server 16 may receive input data from the AI devices 11 to 15, may infer a result value for received input data using a learning model, and may generate a response or control instruction based on the inferred result value to transmit the response or control instruction to the AI devices 11 to 15.

Alternatively, the AI devices 11 to 15 may infer a result value for input data using a direct learning model and may generate a response or control command based on the inferred result value.

$$〈 AI + robot 〉$$

The robot 11 may be implemented as a guide robot, a transport robot, a cleaning robot, a wearable robot, an entertainment robot, a pet robot, an unmanned flying robot, or the like by applying an AI technology.

The robot 11 may include a robot control module for controlling operations, and the robot control module may be a software module or a chip in which a software module is implemented using hardware.

By using sensor information acquired from various types of sensors, the robot 11 may acquire state information of the robot 11, may detect (recognize) a surrounding environment and an object, may generate map data, may determine a movement route and a driving plan, may determine a response to a user interaction, or may determine operations.

Here, the robot 11 may use sensor information acquired from at least one sensor of a LiDAR, a radar, and a camera to determine a movement path and a driving plan.

The robot 11 may perform the above-described operations using a learning model consisting of at least one artificial neural network. For example, the robot 11 may recognize a surrounding environment and an object using the learning model and may determine operations using recognized surrounding environment information or object information. Here, the learning model may be trained directly in the robot 11 or may be trained in an external device such as the AI server 16.

In this case, the robot 11 may directly use the learning model to generate a result to perform operations, or may transmit sensor information to an external device such as the AI server 16 and receive a result generated according to the transmitted sensor information to perform operations.

The robot 11 may determine a movement route and a driving plan using at least one of map data, object information detected from sensor information, and object information acquired from an external device, and a driving unit may be controlled to drive the robot 11 according to the determined movement path and driving plan.

The map data may include object identification information about various objects disposed in a space in which the robot 11 moves. For example, the map data may include object identification information about fixed objects such as walls and doors and movable objects such as pots and desks. The object identification information may include a name, a type, a distance, a position, and the like.

In addition, the robot 11 may perform operations or may travel by controlling the driving unit based on the control/interaction of a user. In this case, the robot 11 may acquire intention information of an interaction due to the operation or voice utterance of a user and may determine a response based on the acquired intention information to perform operations.

$$〈 AI + self - driving 〉$$

The self-driving vehicle 12 may be implemented as a mobile robot, a vehicle, an unmanned aerial vehicle, or the like by applying an AI technology.

The self-driving vehicle 12 may include a self-driving control module for controlling a self-driving function, and the self-driving control module may be a software module or a chip in which a software module is implemented using hardware. The self-driving control module may be included inside the self-driving vehicle 12 as a component thereof, or may be provided as separate hardware outside the self-driving vehicle 12 and connected to the self-driving vehicle 12.

By using sensor information acquired from various types of sensors, the self-driving vehicle 12 may acquire state information of the self-driving vehicle 12, may detect (recognize) a surrounding environment and an object, may generate map data, may determine a movement route and a driving plan, or may determine operations.

Here, in order to determine a movement path and driving plan, like the robot 11, the self-driving vehicle 12 may use sensor information acquired from at least one sensor of a LiDAR, a radar, and a camera.

In particular, the self-driving vehicle 12 may recognize an environment or object in an area in which a field of view is blocked or an area at a certain distance or more by receiving sensor information from external devices or may directly receive recognized information from the external devices.

The self-driving vehicle 12 may perform the above-described operations using a learning model consisting of at least one artificial neural network. For example, the self-driving vehicle 12 may recognize a surrounding environment and an object using the learning model and may determine a driving flow using recognized surrounding environment information or object information. Here, the learning model may be trained directly in the self-driving vehicle 12 or from an external device such as the AI server 16.

In this case, the self-driving vehicle 12 may directly use the learning model to generate a result to perform operations or may transmit sensor information to an external device such as the AI server 16 and receive a result generated according to the transmitted sensor information to perform operations.

The self-driving vehicle 12 may determine a movement route and a driving plan using at least one of map data, object information detected from sensor information, and object information acquired from an external device, and a driving unit may be controlled to drive the self-driving vehicle 12 according to the determined movement path and driving plan.

The map data may include object identification information about various objects disposed in a space (for example, on a road) in which the self-driving vehicle 12 travels. For example, the map data may include object identification information about fixed objects such as streetlights, rocks, and buildings and movable objects such as vehicles and pedestrians. The object identification information may include a name, a type, a distance, a position, and the like.

In addition, the self-driving vehicle 12 may perform operations or may travel by controlling the driving unit based on the control/interaction of a user. In this case, the self-driving vehicle 12 may acquire intention information of an interaction due to the operation or voice utterance of a user and may determine a response based on the acquired intention information to perform operations.

$$〈 AI + XR 〉$$

The XR device 13 may be implemented as a head-mount display (HMD) a head-up display (HUD) provided in a vehicle, a television, a mobile phone, a smartphone, a computer, a wearable device, a home appliance, digital signage, a vehicle, a fixed type robot, a mobile robot, or a movable type robot by applying an AI technology.

The XR device 13 may generate position data and attribute data about three-dimensional points by analyzing three-dimensional point cloud data or image data acquired through various sensors or from an external device, may acquire information about a surrounding space or a real object based on the generated position data and attribute data, and may output an XR object by rendering the XR object to be output. For example, the XR device 13 may output an XR object including additional information about a recognized object by making the XR object correspond to the corresponding recognized object.

The XR device 13 may perform the above-described operations using a learning model consisting of at least one artificial neural network. For example, the XR device 13 may recognize a real object from three-dimensional point cloud data or image data using the learning model and may provide information corresponding to the recognized real object. Here, the learning model may be trained directly in the XR device 13 or may be trained in an external device such as the AI server 16.

In this case, the XR device 13 may directly use the learning model to generate a result to perform operations, or may transmit sensor information to an external device such as the AI server 16 and receive a result generated according to the transmitted sensor information to perform operations.

$$〈 AI + robot + self - driving 〉$$

The robot 11 may be implemented as a guide robot, a transport robot, a cleaning robot, a wearable robot, an entertainment robot, a pet robot, an unmanned flying robot, or the like by applying an AI technology and a self-driving technology.

The robot 11 to which an AI technology and a self-driving technology are applied may be a robot itself with a self-driving function or the robot 11 that interacts with the self-driving vehicle 12.

The robot 11 with a self-driving function may be any device that autonomously travels along a given flow without user control or that autonomously determines a flow to travel.

The robot 11 and the self-driving vehicle 12 which have a self-driving function may use a common sensing method to determine at least one of a movement route and a driving plan. For example, the robot 11 and the self-driving vehicle 12 which have a self-driving function may determine at least one of a movement route and a driving plan using information detected through a LiDAR, a radar, or a camera.

The robot 11 interacting with the self-driving vehicle 12 may be present separately from the self-driving vehicle 12 and may perform operations associated with a self-driving function inside or outside the self-driving vehicle 12 or associated with a user in the self-driving vehicle 12.

In this case, the robot 11 interacting with the self-driving vehicle 12 may control or assist with the self-driving function of the self-driving vehicle 12 by acquiring sensor information on behalf of the self-driving vehicle 12 to provide the sensor information to the self-driving vehicle 12, or by acquiring sensor information and generating surrounding environment information or object information to provide the surrounding environment information or object information to the self-driving vehicle 12.

Alternatively, the robot 11 interacting with the self-driving vehicle 12 may control functions of the self-driving vehicle 12 by monitoring a user in the self-driving vehicle 12 or through an interaction with the user. For example, when it is determined that a driver is drowsy, the robot 11 may activate the self-driving function of the self-driving vehicle 12 or assist in controlling a driving unit of the self-driving vehicle 12. Here, a function of the self-driving vehicle 12 controlled by the robot 11 may not only simply include a self-driving function, but may also include a function provided by a navigation system or audio system provided inside the self-driving vehicle 12.

Alternatively, the robot 11 interacting with the self-driving vehicle 12 may provide information to the self-driving vehicle 12 or may assist with a function outside the self-driving vehicle 12. For example, the robot 11 may provide traffic information including signal information or the like to the self-driving vehicle 12 like a smart traffic light or the like or may interact with the self-driving vehicle 12 to automatically connect an electric charger to a charging port like an automatic electric charger of an electric vehicle.

$$〈 AI + robot + XR 〉$$

The robot 11 may be implemented as a guide robot, a transport robot, a cleaning robot, a wearable robot, an entertainment robot, a pet robot, an unmanned flying robot, or the like by applying an AI technology and an XR technology.

The robot 11 to which an XR technology is applied may be a robot that is subjected to control/interaction in an XR image. In this case, the robot 11 may be distinguished from the XR device 13 and may interwork with the XR device 13.

When the robot 11 that is subjected to control/interaction in an XR image acquires sensor information from sensors including a camera, the robot 11 or the XR device 13 may generate the XR image based on the sensor information, and the XR device 13 may output the generated XR image. The robot 11 may operate based on a control signal input through the XR device 13 or an interaction of a user.

For example, a user may confirm an XR image corresponding to a time point of the robot 11 remotely interworking through an external device such as the XR device 13, may adjust a self-driving route of the robot 11 through an interaction, may control the operation or driving, or may confirm information about a nearby object.

$$〈 AI + self - driving + XR 〉$$

The self-driving vehicle 12 may be implemented as a mobile robot, a vehicle, an unmanned aerial vehicle, or the like by applying an AI technology and an XR technology.

The self-driving vehicle 12 to which an XR technology is applied may be a self-driving vehicle equipped with a component for providing an XR image, a self-driving vehicle that is subjected to control/interaction in an XR image, or the like. In particular, the self-driving vehicle 12 that is subjected to control/interaction in an XR image is distinguished from the XR device 13 and may interwork with the XR device 13.

The self-driving vehicle 12 equipped with the component for providing an XR image may acquire sensor information from sensors including a camera and may output an XR image generated based on the acquired sensor information. For example, the self-driving vehicle 12 may include an HUD to output an XR image, thereby providing a passenger with an XR object corresponding to a real object or an object on a screen.

In this case, when the XR object is output to the HUD, at least a portion of the XR object may be output to overlap a real object toward which a passenger's gaze is directed. On the other hand, when the XR object is output to a display provided inside the self-driving vehicle 12, at least a portion of the XR object may be output to overlap an object on a screen. For example, the self-driving vehicle 12 may output an XR object corresponding to an object such as a lane, another vehicle, a traffic light, a traffic sign, a two-wheeled vehicle, a pedestrian, or a building.

When the self-driving vehicle 12 that is subjected to control/interaction in an XR image may acquire sensor information from sensors including a camera, the self-driving vehicle 12 or the XR device 13 may generate an XR image based on the sensor information, and the XR device 13 may output the generated XR image. The self-driving vehicle 12 may operate based on a control signal input through an external device such as the XR device 13 or an interaction of a user.

### [XR Technology]

XR is a general term for virtual reality (VR), augmented reality (AR), and mixed reality (MR). A VR technology provides a real-world object and background only as a computer-generated (CG) image, an AR technology provides a virtually generated CG image on a real object image, and an MR technology is a computer graphics technology that mixes and combines virtual objects into the real world.

The MR technology is similar to the AR technology in that a real object and a virtual object are shown together. However, in the AR technology, a virtual object is used in a form that complements a real object, but in the MR technology, a virtual object and a real object are used in an equal manner.

The XR technology can be applied to an HMD, an HUD, a mobile phone, a tablet personal computer (PC), a laptop, a desktop, a television (TV), digital signage, and the like. A device to which the XR technology is applied may be referred to as an XR device.

Hereinafter, an electronic device providing XR according to an embodiment of the present invention will be described. In particular, a projection device applied to AR and an electronic device including the same will be described in detail.

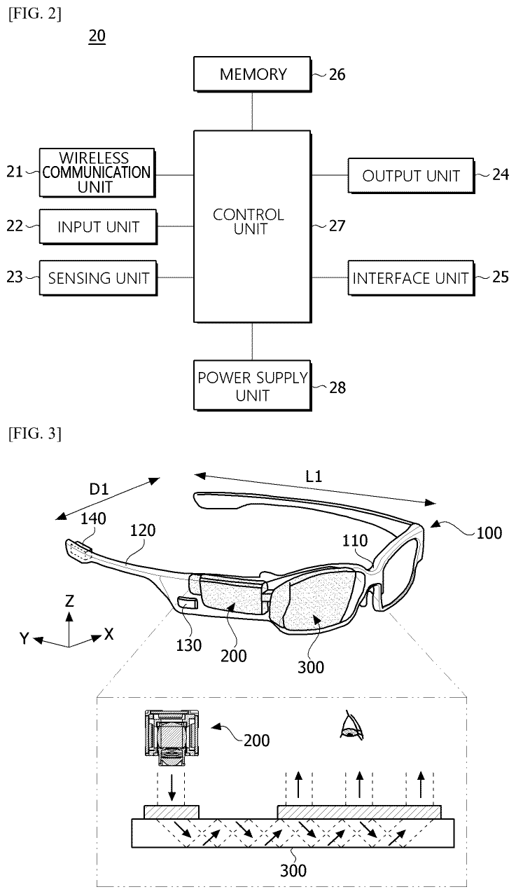

FIG. 2 is a block diagram illustrating a configuration of an electronic device 20 for XR according to an embodiment of the present invention.

Referring to FIG. 2, the electronic device 20 for XR may include a wireless communication unit 21, an input unit 22, a sensing unit 23, an output unit 24, an interface unit 25, a memory 26, a control unit 27, and a power supply unit 28. Since the components shown in FIG. 2 are not essential for implementing the electronic device 20, the electronic device 20 described in the present specification may include more or fewer components than listed above.

More specifically, among the above components, the wireless communication unit 21 may include one or more modules that enable wireless communication between the electronic device 20 and a wireless communication system, between the electronic device 20 and another electronic device, or between the electronic device 20 and an external server. In addition, the wireless communication unit 21 may include one or more modules that connect the electronic device 20 to one or more networks.

The wireless communication unit 21 may include at least one of a broadcast reception module, a mobile communication module, a wireless Internet module, a short-range communication module, and a position information module.

The input unit 22 may include a camera or an image input unit for inputting an image signal, a microphone or an audio input unit for inputting an audio signal, and a user input unit (for example, a touch key or a push key (mechanical key)) for receiving information from a user. Voice data or image data collected by the input unit 22 may be analyzed and processed as a control instruction of a user.

The sensing unit 23 may include one or more sensors for sensing at least one of information in the electronic device 20, information about an environment surrounding the electronic device 20, and user information.

For example, the sensing unit 23 may include at least one of a proximity sensor, an illumination sensor, a touch sensor, an acceleration sensor, a magnetic sensor, a G-sensor, a gyroscope sensor, a motion sensor, a red-green-blue (RGB) sensor, an infrared sensor (IR sensor), a finger scan sensor, an ultrasonic sensor, an optical sensor (for example, a photographing device), a microphone, a battery gauge, an environmental sensor (for example, a barometer, a hygrometer, a thermometer, a radiation detection sensor, a heat detection sensor, or a gas detection sensor), and a chemical sensor (for example, an electronic nose, a healthcare sensor, or a biometric sensor). Meanwhile, in the electronic device 20 disclosed in the present specification, information detected from at least two of these sensors may be combined and used.

The output unit 24 may be for generating output related to a visual sense, an auditory sense, or a haptic sense and may include at least one of a display unit, an audio output unit, a haptic module, and an optical output unit. The display unit may form an inter-layered structure with a touch sensor or may be formed integrally therewith to implement a touchscreen. The touchscreen may function as a user input device that provides an input interface between the electronic device 20 for AR and a user, and at the same time, may provide an output interface between the electronic device 20 for AR and the user.

The interface unit 25 serves as a passageway for various types of external devices connected to the electronic device 20. Through the interface unit 25, the electronic device 20 may receive VR or AR content from an external device and may perform a mutual interaction by exchanging various input signals, sensing signals, and data.

For example, the interface unit 25 may include at least one of a wired/wireless headset port, an external charger port, a wired/wireless data port, a memory card port, a port for connecting a device equipped with an identification module, an audio input/output (I/O) port, a video I/O port, and an earphone port.

In addition, the memory 26 stores data for supporting various functions of the electronic device 20. The memory 26 may store a plurality of application programs (or applications) executed by the electronic device 20, data for the operation of the electronic device 20, and commands. At least some of these application programs may be downloaded from an external server through wireless communication. In addition, at least some of these application programs may be present on the electronic device 20 from the time of shipment for basic functions of the electronic device 20 (for example, functions of receiving a call, placing a call, receiving a message, and sending a message).

In addition to operations related to the application program, the control unit 27 typically controls the overall operation of the electronic device 20. The control unit 27 may process signals, data, information, and the like input or output through the components described above.

In addition, the control unit 27 may control at least some of the components by executing the application program stored in the memory 26, thereby providing appropriate information to a user or processing a function. Furthermore, in order to execute the application program, the control unit 27 may combine and operate at least two of the components included in the electronic device 20.

In addition, the control unit 27 may detect the movement of the electronic device 20 or a user using a gyroscope sensor, a gravity sensor, a motion sensor, or the like included in the sensing unit 23. Alternatively, the control unit 27 may detect an object approaching the electronic device 20 or a user using a proximity sensor, an illumination sensor, a magnetic sensor, an infrared sensor, an ultrasonic sensor, an optical sensor, or the like included in the sensing unit 23. In addition, the control unit 27 may detect the movement of a user through sensors provided in a controller that operates in conjunction with the electronic device 20.

In addition, the control unit 27 may perform operations (or functions) of the electronic device 20 using the application program stored in the memory 26.

The power supply unit 28 may receive external power or internal power under the control of the control unit 27 and may supply power to each of the components included in the electronic device 20. The power supply unit 28 may include a battery, and the battery may be provided in an embedded or replaceable form.

At least some of the above components may operate cooperatively with each other to implement the operation, control, or control method of the electronic device according to various embodiments that will be described below. In addition, the operation, control, or control method of the electronic device may be implemented on the electronic device by executing at least one application program stored in the memory 26.

Hereinafter, descriptions will be provided based on embodiments in which an electronic device described as an example of the present invention is applied as an HMD. However, embodiments of the electronic device according to the present invention may include a mobile phone, a smartphone, a laptop computer, a digital broadcasting terminal, a personal digital assistant (PDA), a portable multimedia player (PMP), a navigation device, a slate PC, a tablet PC, an ultrabook, and a wearable device. In addition to the HMD, the wearable device may also include a smart watch, contact lenses, VR/AR/MR glasses, and the like.

FIG. 3 is a perspective view of an electronic device for AR according to an embodiment of the present invention.

As shown in FIG. 3, the electronic device according to the embodiment of the present invention may include a frame 100, a projection device 200, and a display unit 300.

The electronic device may be provided as a glass-type electronic device (smart glass). The glass-type electronic device may be provided to be worn on the head of a human body and may include the frame 100 (case, housing, or the like) 100 for this purpose. The frame 100 may be formed of a flexible material to be easy to wear.

The frame 100 is supported on the head and provides a space for mounting various parts. As shown, an electronic component such as the projection device 200, a user input unit 130, or an audio output unit 140 may be mounted on the frame 100. In addition, a lens covering at least one of the left eye and the right eye may be removably mounted on the frame 100.

The frame 100 may have the shape of glasses worn on the face of a user's body as shown in the drawing, but the present invention is not necessarily limited thereto. The frame 100 may also have the shape of goggles or the like worn in close contact with the face of a user.

The frame 100 may include a front frame 110 having at least one opening, and a pair of side frames 120 that extend in a Y direction (see FIG. 3) intersecting the front frame 110 and are parallel to each other.

In the frame 100, a length DI in an X direction may be equal to or different from a length LI in the Y direction.

The projection device 200 is provided to control various electronic components provided in the electronic device. The projection device 200 may also be called an “optical output device,” “optical projection device,” “light irradiation device,” “optical device,” or the like.

The projection device 200 may generate an image or a video of successive images shown to a user. The projection device 200 may include an image source panel that generates an image and a plurality of lenses that diffuse and converge light generated by the image source panel.

The projection device 200 may be fixed to one side frame 120 of two side frames 120. For example, the projection device 200 may be fixed inside or outside any one side frame 120 or may be integrally formed by being embedded inside any one side frame 120. Alternatively, the projection device 200 may be fixed to the front frame 110 or provided separately from the electronic device.

The display unit 300 may be implemented as an HMD type. The HMD type is a display type that is mounted on the head and displays an image directly in front of the eyes of a user. When a user wears the electronic device, the display unit 300 may be positioned to correspond to at least one of the left eye and the right eye to provide an image directly in front of the eyes of the user. In this drawing, the display unit 300 is positioned at a portion corresponding to the right eye to output an image toward the right eye of the user. However, as described above, the present invention is not limited thereto, and the display unit 300 may be disposed on both the left eye and the right eye.

The display unit 300 may allow the user to visually perceive an external environment and may simultaneously allow an image generated by the projection device 200 to be shown to the user. For example, the display unit 300 may project an image onto a display area using a prism.

The display unit 300 may be formed to be transparent such that a projected image and a general forward field of view (a range that a user sees through their eyes) may be viewed simultaneously. For example, the display unit 300 may be semi-transparent and may be formed of an optical element including glass.

The display unit 300 may be inserted into and fixed in an opening included in the front frame 110 or may be positioned on a rear surface of the opening (that is, between the opening and the user) and fixed to the front frame 110. Although the drawing illustrates an example in which the display unit 300 is positioned on the rear surface of the opening and fixed to the front frame 110, the display unit 300 may be positioned and fixed at one of various positions of the frame 100.

As shown in FIG. 3, in the electronic device, when the projection device 200 allows image light of an image to be incident on one side of the display unit 300, the image light is emitted to the other side through the display unit 300, thereby allowing a user to view an image generated by the projection device 200.

Accordingly, the user may view an external environment through the opening of the frame 100 and may also simultaneously view an image generated by the projection device 200. That is, an image output through the display unit 300 may be seen overlapping a general field of view. The electronic device may provide AR for showing one image by overlapping a virtual image on a real image or background using such display characteristics.

Furthermore, in addition to such driving, images generated from an external environment and the projection device 200 may be provided to a user with a time difference for a short period of time that is not perceived by a person. For example, in one frame, an external environment may be provided to a person in one section, and in another section, an image from the projection device 200 may be provided to the person.

Alternatively, both of an overlap and a time difference may be provided.

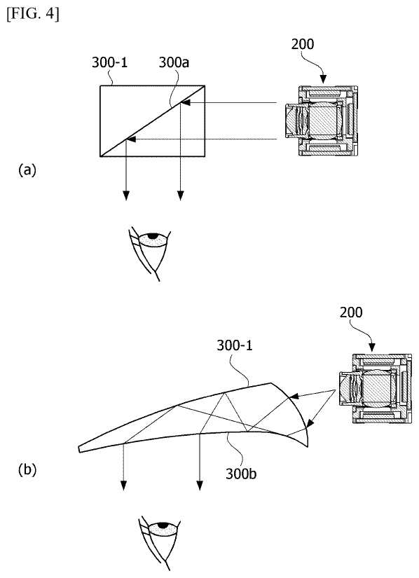

FIGS. 4 to 6 show conceptual views for describing various display methods applicable to a display unit according to an embodiment of the present invention.

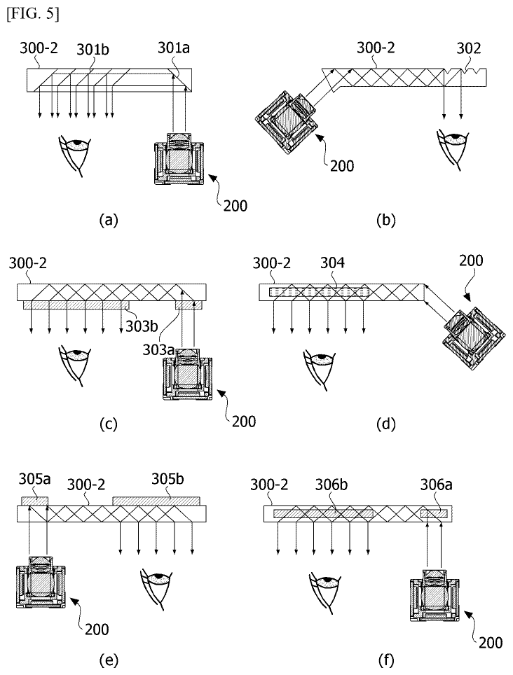

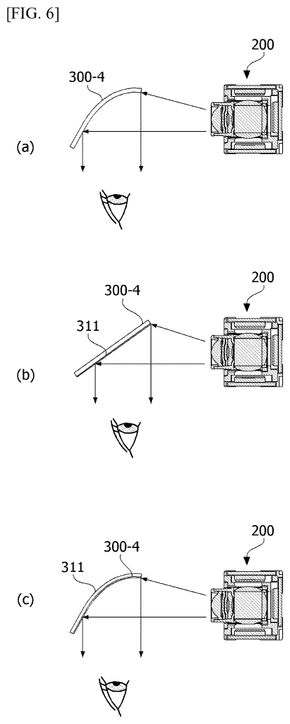

Specifically, FIG. 4 shows views for describing an embodiment of a prism type optical element. FIG. 5 shows views for describing an embodiment of a waveguide (or wave guide) type optical element. FIG. 6 shows views for describing an embodiment of a surface reflection type optical element.

As shown in FIG. 4, the prism type optical element may be used in a display unit 300-1 according to an embodiment of the present invention.

In an embodiment, as shown in FIG. 4A, as the prism type optical element, a flat type glass optical element in which a surface on which image light is incident and a surface 300a from which image light is emitted are planar surfaces may be used, or as shown in FIG. FIG. 4B, a freeform glass optical element in which a surface from which image light 300b is emitted is formed as a curved surface without a constant radius of curvature may be used.

The flat type glass optical element may receive image light generated by a projection device 200 through a flat side surface, may reflect the image light through a total reflection mirror 301a provided therein, and thus may emit the image light toward a user. Here, the total reflection mirror 301a provided inside the flat type glass optical element may be formed inside the flat type glass optical element by a laser.

The freeform glass optical element may be provided to become thinner away from an incidence surface, may receive image light generated by the projection device 200 through a curved side surface, may totally reflect the image light therein, and thus may emit image light toward a user.

As shown in FIG. 5, the waveguide (or wave guide) type optical element or a light guide optical element (LOE) may be used in a display unit 300-2 according to another embodiment of the present invention.

In an embodiment, examples of the waveguide (or wave guide) or light guide type optical element may include a segmented beam splitter type glass optical element as shown in FIG. 5A, a sawtooth prism type glass optical element as shown in FIG. 5B, a glass optical element having a diffractive optical element (DOE) as shown in FIG. 5C, a glass optical element having a hologram optical element (HOE) as shown in FIG. 5D, a glass optical element having a passive grating as shown in FIG. 5E, and a glass optical element having an active grating as shown in FIG. 5F.

As shown, the segmented beam splitter type glass optical element as shown in FIG. 5A may include a total reflection mirror 301a at a side on which a light image is incident inside the glass optical element and a segmented beam splitter 301b at a side from which a light image is emitted.

Accordingly, an optical image generated by a projection device 200 may be totally reflected by the total reflection mirror 301a inside the glass optical element, and the totally reflected optical image may be guided in a length direction of glass, may be partially separated and emitted by the segmented beam splitter 301b, and thus may be recognized by the eyes of a user.

In the sawtooth prism glass optical element as shown in FIG. 5B, image light of the projection device 200 may be diagonally incident on a side surface of glass, may be totally reflected into the glass, may be emitted to the outside of the glass by a sawtooth-shaped unevenness 302 provided at a side from which the image light is emitted, and thus may be recognized by the eyes of a user.

The glass optical element having the DOE as shown in FIG. 5C may include a first diffractive portion 303a on a surface at a side on which a light image is incident and a second diffractive portion 303b on a surface at a side from which a light image is emitted. The first and second diffractive portions 303a and 303b may be provided in a form in which a specific pattern is patterned on a surface of glass or a separate diffractive film is attached.

Accordingly, a light image generated by the projection device 200 may be diffracted by being incident through the first diffractive portion 303a, may be totally reflected, may be guided in a length direction of the glass, may be emitted through the second diffractive portion 303b, and thus may be recognized by the eyes of a user.

The glass optical element having the HOE as shown in FIG. 5D may include an out-coupler 304 inside glass at a side from which a light image is emitted. Accordingly, a light image from the projection device 200 may be diagonally incident through a side surface of glass, may be totally reflected, may be guided in a length direction of the glass, may be emitted by the out-coupler 304, and thus may be recognized by the eyes of a user. A structure of the HOE may be slightly changed and further subdivided into a structure with a passive grating and a structure with an active grating.

The glass optical element having the passive grating as shown in FIG. 5E may include an in-coupler 305a on a surface opposite to a surface of glass at a side on which a light image is incident, and an out-coupler 305b on a surface opposite to a surface of the glass at a side from which a light image is emitted. Here, the in-coupler 305a and the out-coupler 305b may be provided in the form of a film having a passive grating.

Accordingly, a light image incident on the surface of the glass at a side on which the light image is incident may be totally reflected by the in-coupler 305a provided on the opposite surface, may be guided in a length direction of the glass, may be emitted through the opposite surface of the glass by the out-coupler 305b, and thus may be recognized by the eyes of a user.

The glass optical element having the active grating as shown in FIG. 5F may include an in-coupler 306a formed as an active grating inside glass at a side on which a light image is incident, and an out-coupler 306b formed as an active grating inside the glass at a side from which a light image is emitted.

Accordingly, a light image incident on the glass may be totally reflected by the in-coupler 306a, may be guide in a length direction of the glass, may be emitted to the outside of the glass by the out-coupler 306b, and thus may be recognized by the eyes of a user.

A pin mirror type optical element may be used as a display unit according to a modified example.

In addition, as shown in FIG. 6A, in a surface reflection type optical element of a freeform combiner type, in order to serve as a combiner, freeform combiner glass in which a plurality of flat surfaces having different incident angles of a light image may be formed of one glass to form an overall curved surface may be used. In such freeform combiner glass 300, a light image may be emitted to a user at different angles according to areas.

In a surface reflection type optical element of a flat HOE type as shown in FIG. 6B, an HOE 311 may be applied or patterned on a surface of flat glass, and an optical image incident from a projection device 200 may pass through the HOE 311, may be reflected by a surface of the glass, and then may pass through the HOE 311 again to be emitted toward a user.

In a surface reflection type optical element of a freeform HOE type as shown in FIG. 6C, an HOE 313 may be applied or patterned on a surface of glass, and an operating principle may be the same as that described with reference to FIG. 6B.

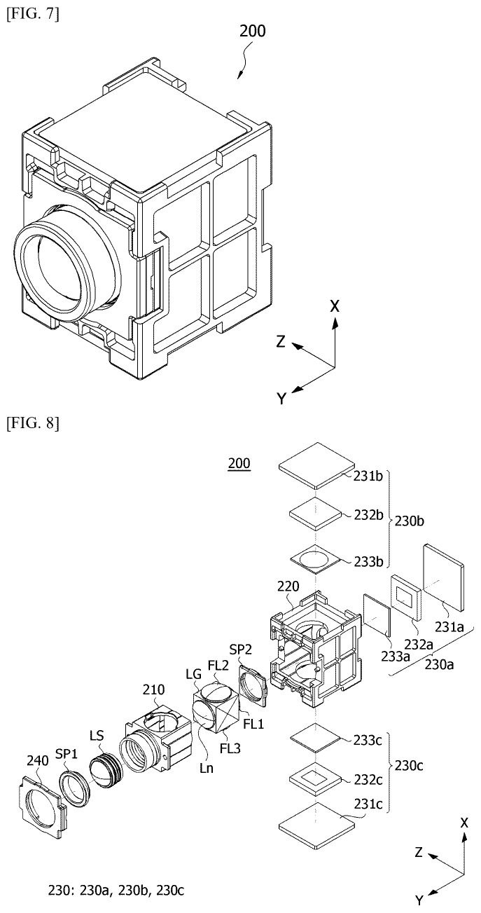

FIG. 7 is a perspective view of a projection device according to one embodiment. FIG. 8 is an exploded perspective view of the projection device according to one embodiment.

Referring to FIGS. 7 and 8, a projection device 200 according to one embodiment may include an outer lens LS, a barrel 210, a housing 220, a light source unit 230, a light guide LG, a lens FL, and an additional housing 240. In addition, the projection device 200 may include a first spacer SP1 and a second spacer SP2.

First, the outer lens LS may be inserted into the barrel 210. That is, the barrel 210 may be positioned inside the projection device 200 and may accommodate the outer lens LS. In addition, the barrel 210 may accommodate the light guide LG, the lens FL, the first spacer SP1, and the second spacer SP2.

The barrel 210 may have a space for accommodating the components described above or additional optical elements. For example, the barrel 210 may include a first groove and a second groove which will be described below. The first groove may accommodate the outer lens LS. The light guide LG may be disposed in the second groove. In addition, the first groove and the second groove may be disposed to be spaced apart from each other in the barrel 210. That is, the barrel 210 may have spaces (for example, grooves) in which the outer lens LS and the light guide LG are disposed, and the spaces may be separated or spaced apart from each other. Accordingly, the insertion or combination of the outer lens and the light guide may be facilitated.

On the other hand, when the spaces are connected to each other, the projection device may be miniaturized.

The outer lens LS may be accommodated in the barrel 210, and the first spacer SP1 may be positioned outside the outer lens LS. The first spacer SP1 may be positioned outside the outer lens LS accommodated in the first groove of the barrel 210 to prevent detachment of the outer lens LS.

The barrel 210 may include a plurality of holes connected to the second groove. The plurality of holes may be formed in a side surface of the barrel 210. Accordingly, light emitted from the light source unit 230 to be described below may be incident on the light guide LG. Furthermore, light incident on the light guide LG may be reflected to pass or be transmitted through the outer lens LS and may be provided to the waveguide or wave guide described above. For this purpose, the first groove and the second groove may be connected to each other through a through-hole. That is, light reflected from the light guide LG in the second groove through the through-hole may be provided to the outer lens LS in the first groove. In addition, as described above, light from the light source unit 230 may be emitted to the inner light guide LG through the plurality of holes formed in the side surface of the barrel 210.

The light guide LG may be positioned in the barrel 210. The light guide LG may be connected to the lens FL to be described below.

The light guide LG may consist of at least one prism. For example, the light guide LG may be formed by coupling or joining a plurality of prisms. The light guide LG may include a prism. The prism may include a reflective member, for example, an x-prism. As an example, the light guide LG may have a structure in which at least two prisms are coupled. In addition, the light guide LG may be a non-polarizing prism. That is, the light guide LG may not perform polarization on light emitted from light sources 232a, 232b, and 232c.

The light guide LG may include at least two coated surfaces (reflective members or reflective sheets). At least one of the at least two coated surfaces may reflect light with a first wavelength and light with a second wavelength and may transmit light with a third wavelength. That is, the coated surface may reflect light in a certain wavelength band. Accordingly, for light beams emitted from a plurality of light sources 232a, 232b, and 232c, light beams in a desired wavelength band may each be reflected from the light guide LG. For example, light passing through the light guide LG may be provided to the outer lens LS.

The lens FL may be connected to the light guide LG. The lens FL may be positioned adjacent to the light guide LG. For example, the lens FL may be in contact with the light guide. That is, the lens FL may be in contact with the light guide LG. In addition, the light guide LG may be in contact with the lens FL.

The lens FL may be coupled to the light guide LG. In this case, the lens FL may be coupled to the light guide LG through a joining member or a coupling member. The joining member or the coupling member may be positioned between the lens FL and the light guide LG.

At least one lens FL may be positioned on an outer surface of the light guide LG. For example, the number of lenses FL may correspond to the number of light sources of the light source unit 230 to be described below. When the number of light sources is three, the number of lenses FL may also be three.

For example, the lens FL may include a first lens, a second lens, and a third lens to correspond to the light sources. The first lens may correspond to a first light source unit. The second lens may correspond to a second light source unit. The third lens may correspond to a third light source unit. That is, the first to third lenses may each receive light emitted from one of the first to third light source units.

The second spacer SP2 may be positioned in the barrel 210. For example, the second spacer SP2 may be larger than the light guide LG or the lens FL. The second spacer SP2 may be disposed outside the light guide LG and the lens FL. Accordingly, the light guide LG and the lens FL may not be separated from the barrel 210. In other words, the second spacer SP2 may prevent the light guide LG and the lens FL from being separated from the barrel 210.

The housing 220 may be positioned outside the barrel 210. The housing 220 may surround the barrel 210. For example, the housing 220 may be positioned to surround at least an area of the barrel 210. Further, the housing 220 may include a space for accommodating a light source. In addition, the housing 220 may include at least one housing hole. The light source may be disposed in the housing hole. In addition, light emitted from the light source through at least one housing hole may be provided to the lens FL and the light guide LG. The housing 220 may be positioned outside the barrel 210 and may include a space for accommodating the barrel 210 and the light source unit 230.

At least one light source unit 230 may be provided. As described above, three light sources may be mainly described below. The light source unit 230 may include a first light source unit 230a, a second light source unit 230b, and a third light source unit 230c.

The first light source unit 230a may overlap the outer lens LS in a second direction (Y-axis direction). The second direction (Y-axis direction) may correspond to a direction of light emitted from the projection device 200. That is, the second direction (Y-axis direction) may correspond to a direction in which light emitted from the light source unit 230 is reflected by the light guide LG and emitted to the display unit described above.

The second light source unit 230b and the third light source unit 230c may be positioned to face each other. Alternatively, the second light source unit 230b and the third light source unit 230c may be positioned opposite to each other.

The second light source unit 230b and the third light source unit 230c may overlap each other in a first direction (X-axis direction). The first direction (X-axis direction) may be a direction that is perpendicular to the second direction (Y-axis direction). A third direction (Z-axis direction) may be a direction that is perpendicular to the first and second directions.

The first light source unit 230a may be positioned in an area between the second light source unit 230b and the third light source unit 230c. Directions of light beams emitted from the second light source unit 230b and the third light source unit 230c may be opposite to each other.

Each light source may include a substrate 231a, 231b, or 231c, the light source 232a, 232b, or 232c, and an optical element 233a, 233b, or 233c.

Furthermore, the substrate 231a, 231b, or 231c, the light source 232a, 232b, or 232c, and the optical element 233a, 233b, or 233c may be sequentially positioned in the inside. That is, the optical element may be positioned closer to the light guide LG than the substrate and the light source.

The substrates 231a, 231b, and 231c may be connected to the light sources 232a, 232b, and 232c to transmit electrical energy such that the light sources 232a, 232b, and 232c may emit light.

The substrates 231a, 231b, and 231c may be positioned at the outermost side of the housing 220.

The substrates 231a, 231b, and 231c may include a first substrate 231a, a second substrate 231b, and a third substrate 231c. The first substrate 231a may overlap the light guide LG in the second direction (Y-axis direction). The second substrate 231b and the third substrate 231c may overlap each other in the first direction (X-axis direction). The second substrate 231b and the third substrate 231c may be positioned to face each other in the housing 220. The first substrate 231a may be positioned in an area between the second substrate 231b and the third substrate 231c.

The light sources 232a, 232b, and 232c may emit light. For example, light emitted from the light sources 232a, 232b, and 232c may be incident on the light guide LG in the housing 220. The light guide LG may be positioned in the housing 220.

One or more light sources 232a, 232b, and 232c may be provided. The light sources 232a, 232b, and 232c may include a first light source 232a, a second light source 232b, and a third light source 232c. The light source 232a, 232b, or 232c may be disposed on each substrate.

That is, in the light source unit 230, the light sources 232a, 232b, and 232c may be provided as a single light source or a plurality of light sources. For example, the light sources 232a, 232b, and 232c may include the first light source 232a, the second light source 232b, and the third light source 232c as a plurality of light sources. The first to third light sources 232a to 232c may emit light in the same direction or different directions. For example, the second light source 232b and the third light source 232c may be positioned to face each other. The second light source 232b and the third light source 232c may be positioned to overlap each other in the first direction (X-axis direction). The light guide LG may be positioned between the second light source 232b and the third light source 232c. Accordingly, the light guide LG may overlap the second light source 232b and the third light source 232c.

The first to third light sources 232a to 232c may emit light toward the light guide LG. The first light source 232a may overlap the light guide LG in the second direction. Due to such a configuration, the projection device 200 may include the compact light source unit 230.

In addition, the first light source 232a, the second light source 232b, and the third light source 232c may emit light with wavelengths or colors that are the same as or different from each other. For example, each of the first light source 232a, the second light source 232b, and the third light source 232c may emit red, green, and blue light.

One or more optical elements 233a, 233b, and 233c may be provided. The optical elements 233a, 233b, and 233c may include a first optical element 233a, a second optical element 233b, and a third optical element 233c corresponding to the first light source 232a, the second light source 232b, and the third light source 232c, respectively. The first optical element 233a, the second optical element 233b, and the third optical element 233c may include filters. In addition, the first optical element 233a, the second optical element 233b, and the third optical element 233c may include glass. The first optical element 233a, the second optical element 233b, and the third optical element 233c may filter light. Alternatively, the first optical element 233a, the second optical element 233b, and the third optical element 233c may prematurely block foreign materials from entering the light source. That is, the light source can be protected.

The additional housing 240 may be disposed outside the barrel 210 to surround the barrel 210. The barrel 210 may be coupled to the housing 220 in various coupling manners, and the additional housing 240 may be coupled to the housing 220. The additional housing 240 may also be coupled to the barrel 210. Accordingly, the projection device 200 according to the embodiment may provide improved reliability.

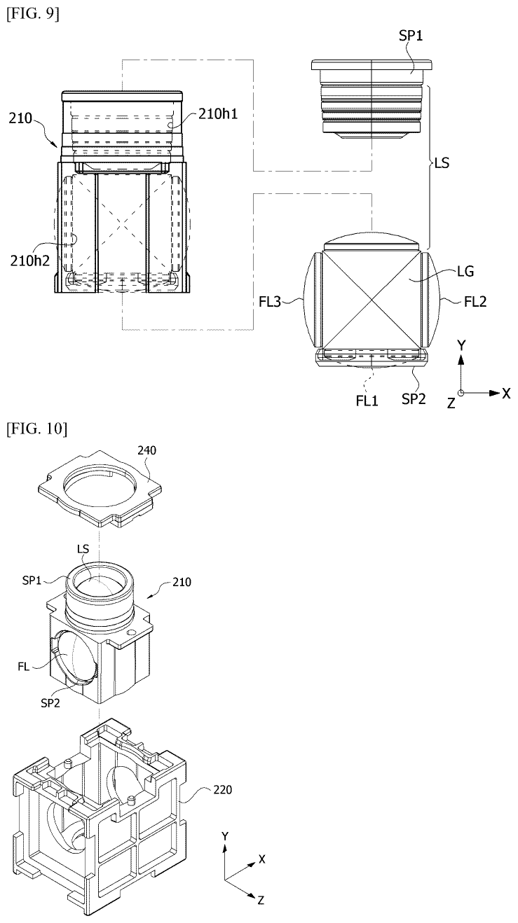

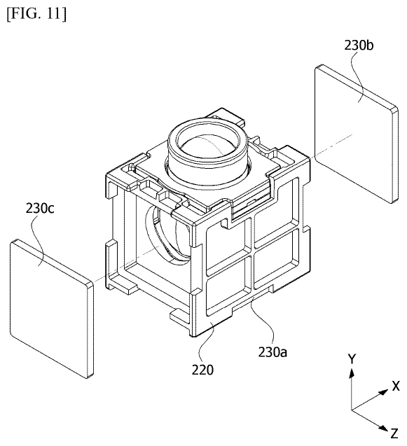

FIG. 9 is a view for describing an outer lens, a first spacer, a light guide, a lens, and a second spacer that are coupled to a barrel in a projection device according to one embodiment. FIG. 10 is a view for describing coupling between the barrel, a housing, and an additional housing in the projection device according to one embodiment. FIG. 11 is a view for describing coupling between the housing and a light source unit in the projection device according to one embodiment.

Referring to FIGS. 9 to 11, in the projection device according to the embodiment, as described above, a barrel 210 may include a first groove 210h1 and a second groove 210h2. The first groove 210h1 and the second groove 210h2 may overlap each other in a second direction (Y-axis direction). Furthermore, the second groove 210h2 and the first groove 210h1 may be sequentially disposed in the second direction (Y-axis direction).

The outer lens may be disposed in the first groove 210h1. The light guide may be disposed in the second groove 210h2.

The first groove 210h1 and the second groove 210h2 may be disposed to be spaced apart from each other in the second direction (Y-axis direction). In addition, the first groove 210h1 and the second groove 210h2 may be connected to each other through a through-hole as described above. Accordingly, light reflected from the light guide in the second groove 210h2 may be provided to the outer lens in the first groove 210h1 and finally output to a display unit.

An outer lens LS may be inserted into the first groove 210h1 of the barrel 210. A first spacer SP1 may be positioned outside the outer lens LS in the first groove 210h1 in the barrel 210. The first spacer SP1 may be in contact with the outer lens LS and may suppress detachment of the outer lens LS as described above.

The light guide LG and lenses FL1, FL2, and FL3 connected to a light guide LG may be inserted into the second groove 210h2. The light guide LG and the lenses FL1, FL2, and FL3 connected to the light guide LG may be positioned in the second groove 210h2. A second spacer SP2 may be positioned outside the light guide LG and the lenses FL1, FL2, and FL3 connected to the light guide LG. The second spacer SP2 may be in contact with the light guide LG or a lens (in particular, a first guide lens FL1). Accordingly, detachment of the light guide LG and the lenses FL1, FL2, and FL3 connected to the light guide LG may be suppressed.

The first spacer SP1 and the second spacer SP2 may be sequentially disposed in the second direction (Y-axis direction). The first spacer SP1 and the second spacer SP2 may overlap each other in the second direction (Y-axis direction). The outer lens LS, the light guide LG, and the first guide lens FL1 may be positioned between the first spacer SP1 and the second spacer SP2. Accordingly, the first spacer SP1 and the second spacer SP2 may overlap the outer lens LS, the light guide LG, and the first guide lens FL1 in the second direction (Y-axis direction).

The barrel 210 may be inserted into a housing 220. That is, the barrel 210 may be positioned in an accommodation hole of the housing 220. Furthermore, the housing 220 and the barrel 210 may be coupled in various joining manners. For example, a protrusion of the housing 220e and a coupling hole of the barrel 210 may be coupled to each other. Further, the housing 220 may be positioned below the barrel 210, and an additional housing 240 may be positioned on the barrel 210. The barrel 210 may maintain an improved coupling force with the housing 220 through the additional housing 240.

After the barrel 210 is accommodated in the housing 220, a plurality of light source units may be inserted into a side surface of the housing 220. For example, a first light source unit 230a, a second light source unit 230b, and a third light source unit 230c may be positioned in the side surface of the housing 220.

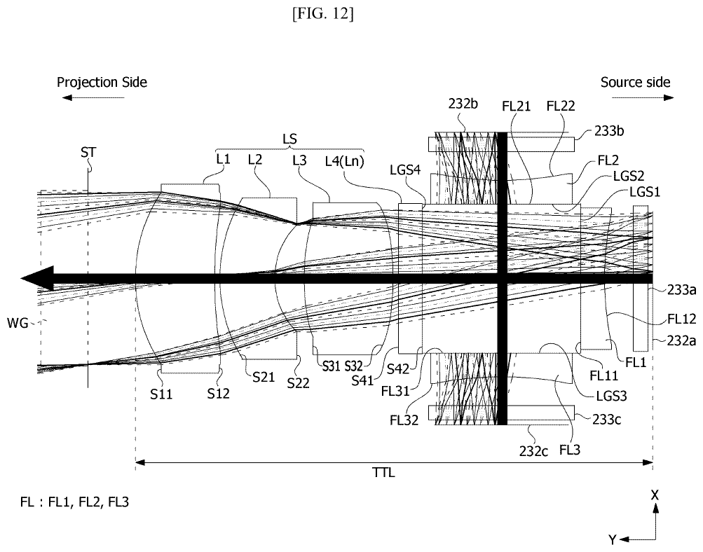

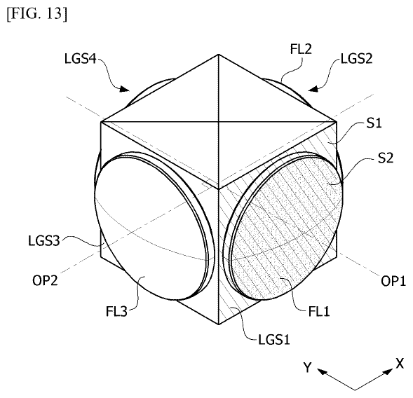

FIG. 12 is a view of an optical system of a projection device according to a first embodiment. FIG. 13 is a perspective view of a light guide, a fourth lens, and a side lens in the projection device according to the embodiment.

Referring to FIGS. 12 and 13, in the projection device according to the first embodiment, the optical system may include a lens group LS, a light guide LG, an optical element (not shown), and a lens FL (or a side lens). Furthermore, the optical system in the projection device may further include light sources 232a, 232b, and 232c. In addition, the optical system in the projection device may include an aperture ST. An outer lens or the lens group LS may also be called “a lens group” or “at least one lens.” In the projection device, a direction from the light guide LG to the lens group LS, the aperture, or the light guide (wave guide) may be referred to as an object direction (or an object side), a projection direction (or a projection side), or a target side (or a target direction). Accordingly, the target side may correspond to a direction from each light source to a waveguide WG based on a light travel path. A direction from the light guide LG to each light source may be referred to as a light source direction (source side), an image direction (or an image side), or a light source side. That is, the light source side may be in a direction from the light guide LG to light. Although the light source side is illustrated in the drawing as being a direction toward a first light source, the light source side may correspond to a direction toward a light source adjacent to a corresponding component for first to third side lenses FL1 to FL3 and first to third optical elements 233a to 233c. For example, the light source side for the second side lens or the second optical element corresponds to a direction toward a second light source 232b.

Specifically, the lens group LS may include N lenses. The lens group LS may include first to N^{th} lenses L1 to Ln. The N lenses may include a first lens L1, a second lens L2, a third lens L3, and an N^{th} lens L4 or Ln in the order in which the first lens L1, the second lens L2, the third lens L3, and the N^{th} lens L4 or Ln are adjacent to the waveguide WG. For example, in the lens group LS, the first to N^{th} lenses L1 to Ln may be sequentially disposed in a direction opposite to an optical axis direction (Y-axis direction) of the lens group. Alternatively, the first to N^{th} lenses L1 to Ln may be sequentially disposed to correspond to the optical axis of the lens group LS.

The light guide LG may have a hexahedral shape. Accordingly, the light guide LG may include a first side surface or first side LGS1 facing a first light source 232a. The light guide LG may include a second side surface or second side LGS2 facing the second light source 232b. The light guide LG may include a third side surface or third side LGS3 facing a third light source 232c. The light guide LG may include a fourth side surface or fourth side LGS4 facing a fourth lens L4 or the N^{th} lens Ln. In addition, the first to fourth sides may face directions other than those of the side surfaces. For example, the first light source 232a may be positioned at the first side of the light guide LG. The second light source 232b may be positioned at the second side of the light guide LG. The third light source 232c may be positioned at the third side of the light guide LG. The lens group LS may be positioned at the fourth side of the light guide LG.

Further, outer lenses, cemented lenses, or lenses FL1 to FL3 may include the first side lens FL1, the second side lens FL2, and the third side lens FL3. The above-described first guide lens may correspond to the first side lens FL1. Furthermore, each side lens or the first side lens may also be called a “lens,” “guide lens,” cemented lens,” or “outer lens.”

The first side LGS1 and the fourth side LGS4 of the light guide LG may be opposite surfaces or opposite to each other. In addition, the second side LGS2 and the third side LGS3 may be opposite surfaces or opposite to each other. For example, the second side LGS2 and the third side LGS3 of the light guide LG may be opposite surfaces or opposite to each other.

In the light guide LG, a first optical axis for the first side LGS1 and the fourth side LGS4 may be orthogonal to a second optical axis for the second side LGS2 and the third side LGS3. A first optical axis OP1 may correspond to an axis of light emitted from the first light source 232a and may be parallel to a second direction (Y-axis direction). A second optical axis OP2 may be parallel to a first direction (X-axis direction). In an embodiment, in a configuration in which optical axes in the first side lens FL1, the second side lens FL2, the third side lens FL3, and the N^{th} lens Ln are orthogonal to each other, due to the orthogonality between the optical axes, a structure for mounting the first to third light sources 232a to 232c and the N^{th} lens in the projection device according to the embodiment can be miniaturized, and the number of processes can be minimized.

The first side lens FL1 may be positioned between the first side LGS1 and the first light source 232a. The second side lens FL2 may be positioned between the second side LGS2 and the second light source 232b. The third side lens FL3 may be positioned between the third side LGS3 and the third light source 232c. The fourth lens L4 or Ln may be positioned between the fourth side LGS4 and the first lens L1.

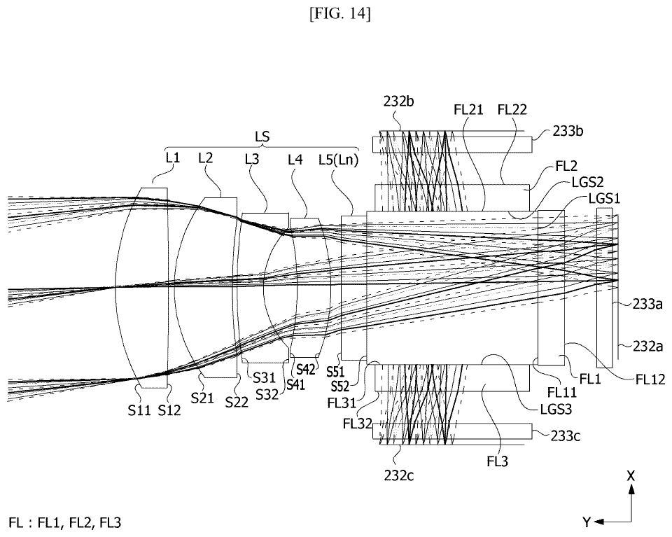

The lens group LS may include at least three or four lenses. As shown in FIG. 14, the lens group LS may include five lenses and may consist of first to fifth lenses L1 to L5. In this case, the N^{th} lens corresponds to the fifth lens L5. However, as shown in the drawing, the outer lens or lens group LS may include four lenses and may consist of the first to fourth lenses L1 to L4. In this case, the N^{th} lens Ln corresponds to the fourth lens L4.

The first lens L1 may be positioned farthest from the fourth side LGS4 of the light guide LG, and the N^{th} lens Ln or fourth lens L4 may be positioned closest to the fourth side LGS4 of the light guide LG.

The first side LGS1 and the fourth side LGS4 of the light guide LG may overlap in an optical axis direction or the second direction.

In an example, the N^{th} lens or the fourth lens L4 may be coupled to the light guide LG. In particular, the fourth lens L4 may be in contact with or close to the fourth side or fourth side LGS4 of the light guide LG.

An outer lens or a side lens FL may be disposed on the light guide LG. For example, the side lens FL may be in contact with the light guide LG. The number of side lenses FL may correspond to the number of light sources. For example, the number of side lenses FL may be three when there are three light sources. In addition, the number of side lenses FL may be one when there is one light source.

Hereinafter, the lens FL may be referred to as “light source lens” or “side lens.” The side lenses FL may include the first side lens FL1, the second side lens FL2, and the third side lens FL3. As described above, the first side lens FL1 may be positioned in an area between the second side lens FL2 and the third side lens FL3. However, the first side lens FL1 may not overlap the second side lens FL2 and the third side lens FL3 in the second direction (Y-axis direction). The first side lens FL1 may be disposed to be misaligned with the second side lens FL2 and the third side lens FL3 in the first direction (X-axis direction). Furthermore, the first side lens FL1 may overlap the light guide LG in the second direction (Y-axis direction). For example, the first side lens FL1 may overlap the light guide LG in a light emission direction of the first light source 232a.

In an embodiment, the first lens L1 and the N−1 lens may have aspherical surfaces. Due to such a configuration, optical performance can be improved.

In addition, optical elements may be disposed between a light source and the light guide LG. For example, the optical elements may include the first optical element, the second optical element, and the third optical element. The light source may include the first light source 232a, the second light source 232b, and the third light source 232c.

The first optical element 233a may be disposed between the first light source 232a and the first side lens FL1. The second optical element 233b may be disposed between the second light source 232b and the second side lens FL2. The third optical element 233c may be disposed between the third light source 232c and the third side lens FL3.

The first optical element 233a may be disposed between the second optical element 233b and the third optical element 233c. The first optical element 233a may not overlap the second optical element 233b and the third optical element 233c in the second direction (Y-axis direction). The first optical element 233a may be disposed to be misaligned with the second optical element 233b and the third optical element 233c in the second direction.

Accordingly, light emitted from the first light source 232a may be provided to the waveguide WG by passing through the first optical element, the first side lens FL1, the light guide LG, and the lens group LS. Light emitted from the second light source 232b may be provided to the waveguide WG by passing through the second optical element, the second side lens FL2, the light guide LG, and the lens group LS. Light emitted from the third light source 232c can be provided to the waveguide WG by passing through the third optical element, the third side lens FL3, the light guide LG, and the lens group LS.

The first lens L1 may include a first surface S11 or a first target surface S11 which is a surface positioned at a waveguide WG side (or the target side or object side). In addition, the first lens L1 may include a second surface S12 or a second target surface S22 which is a surface positioned at a light guide LG side (or the light side, light source side, or image side). The second lens L2 may include a third surface S31 or a third target surface S21 which is a surface positioned at the waveguide WG side. The second lens L2 may include a fourth surface S22 or a fourth target surface S22 which is a surface positioned at the light guide LG side. The third lens L3 may include a fifth surface S31 or a fifth target surface S31 which is a surface positioned at the waveguide WG side. The third lens L3 may include a sixth surface S32 or a sixth target surface S32 which is a surface positioned at the light guide LG side. The fourth lens L4 may include a seventh surface S41 or a fourth target surface S41 which is a surface positioned at the waveguide WG side. The fourth lens L4 may include an eighth surface S42 or an eighth target surface S42 which is a surface positioned at the light guide LG side.

The eighth surface S42 may be in contact with the fourth side LGS4 of the light guide LG. In addition, one surfaces (projection side surfaces) of the first side lens FL1, the second side lens FL2, and the third side lens FL3 may be in contact with the first side, the second side, and the third side of the light guide LG, respectively. In this way, total reflection can be prevented from occurring on the side surfaces (first to fourth sides) of the light guide. For example, total reflection can be suppressed on the fourth side surface LGS4 of the light guide LG so that stray light can be removed.

Furthermore, at least one surface (projection side surface or image side surface) of the first side lens FL1, the second side lens FL2, the third side lens FL3, and the N^{th} lens L4 may be flat. For example, at least one surface (projection side surface) of the first side lens FL1, the second side lens FL2, the third side lens FL3, and the N^{th} lens L4 may have a radius of curvature of 10 or more. Preferably, at least one surface (projection side surface) of the first side lens FL1, the second side lens FL2, the third side lens FL3 and the N^{th} lens L4 may have a radius of curvature of 50 or more.

In addition, a plurality of light beams may be reflected by the light guide and pass through the lens group LS to be radiated toward the aperture ST or waveguide WG. Although light emitted from the first light source 232a is illustrated in the drawing as passing through the light guide LG to be provided to the waveguide, as described above, it should be understood that light emitted from other light sources (the second and third light sources) is also reflected by the light guide LG to be radiated toward the waveguide or the like.

Hereinafter, various embodiments of the present invention will be described based on the above-described content. Furthermore, the content described below may be applied equally, except for content that is contradictory to the content described in other implementations.

In the optical system of the projection device according to the first embodiment, the first light source 232a may be disposed at the first side or the image side of the light guide LG. The lens group LS may be disposed at the fourth side or object side (or the projection side/target side) of the light guide LG. In addition, the first side lens FL1 may be positioned between the first side LGS1 of the light guide LG and the first light source 232a. In an embodiment, the first side LGS1 of the light guide LG may overlap the fourth side LGS4 of the light guide LG in the optical axis direction or the second direction (Y-axis direction) of the lens group LS. In other words, the first side LGS1 and the fourth side LGS4 of the light guide LG may overlap each other and be opposite to each other in the second direction.

In the present embodiment, the first side lens FL1 may be in contact with the light guide LG. For example, the first side lens FL1 may be joined to the first side LGS1 of the light guide LG by a joining member or the like or may be formed integrally with the first side LGS1.

As described above, the lens group LS may include the first to N^{th} lenses L1 to Ln. In an embodiment, the first lens L1 in the lens group LS may be positioned farthest from the fourth side LGS4 of the light guide LG. The fourth lens L4 may be disposed closest to the fourth side LGS4 of the light guide LG. In other words, a length from the fourth side LGS4 to the first lens L1 in the second direction (Y-axis direction) may be greater than a length d4 between the fourth side LGS4 and the fourth lens L4 in the second direction (Y-axis direction). In this case, since the fourth lens L4 is in contact with the fourth side LGS4, the length d4 may be 0.

Furthermore, the third lens L3 and the second lens L2 may be disposed between the first lens L1 and the fourth lens L4 in the second direction.

In an embodiment, a projection side surface or an image side surface of the first lens L1 may be convex toward the target side. For example, the first lens L1 may have a convex surface (first surface) opposite to a surface (second surface) facing the fourth side LGS4 of the light guide LG. That is, the first lens L1 may be convex in the second direction (Y-axis direction). Conversely, the first lens L1 may be concave in a direction opposite to the second direction. In other words, the first surface S11 of the first lens L1 may be concave toward the fourth side LGS4. The first lens L1 may be convex toward the waveguide WG. Accordingly, a light beam or light collected by the light guide LG may be easily guided to a light guide plate or the waveguide WG. In other words, the collected light may be efficiently diffused.

In an embodiment, the second side lens FL2 may be positioned between the second side LGS2 of the light guide LG and the second light source 232b. In addition, the third side lens FL3 may be positioned between the third side LGS3 of the light guide LG and the third light source 232c.

The first side lens FL1 may include a surface FL12 or upper surface adjacent to the first light source 232a. The upper surface FL12 of the first side lens FL1 may be convex or concave upward or toward the first light source 232a.

In the preset embodiment, the upper surface FL12 of the first side lens FL1 may be concave upward or toward the light source. In an embodiment, one surface of each side lens may be flat, and an upper surface thereof may have a positive or negative radius of curvature. For example, the upper surface of each side lens may have a positive radius of curvature.

The second side lens FL2 may include a surface F22 or an upper surface adjacent to the second light source 232b. The upper surface FL22 of the second side lens FL2 may be convex or concave upward or toward the second light source 232b. For example, the upper surface FL22 of the second side lens FL2 may be concave upward.

The third side lens FL3 may include a surface FL32 or an upper surface adjacent to the third light source 232c. The upper surface FL32 of the third side lens FL3 may be convex upward or toward the third light source 232c. For example, the upper surface FL32 of the third side lens FL3 may be concave upward.

In other words, the surface FL12 of the first side lens FL1 adjacent to the first light source may be concave toward the first light source 232a. The surface FL22 adjacent to the second light source of the second side lens FL2 may be concave toward the second light source 232b. The surface FL32 of the third side lens FL3 adjacent to the third light source may be concave toward the third light source 232c. The fourth lens Ln may have a flat structure.

The surfaces FL12, FL22, and FL32 of the first side lens FL1, the second side lens FL2, and the third side lens FL3 adjacent to the light sources 232a, 232b, and 232c may have the same radius of curvature.

Due to such a configuration, a total track length (TTL) can be minimized, and manufacturing yield can be easily secured. The TTL may correspond to a distance on an optical axis from the first surface S11 of the first lens L1 to the light sources 232a, 232b, and 232c. Alternatively, the TTL may correspond to a distance along an optical axis from the first surface S11 of the first lens L1 to the light source. For example, the TTL may correspond to a distance on the optical axis from the first lens L1 to the first light source 232a. The distance on the optical axis or the TTL from the first lens L1 to the first light source 232a may be smaller than or equal to twice a focal length of the optical system including the lens group LS, the light guide LG, and the side lenses FL1, FL2, and FL3. Due to such a configuration, a size of the projection device or optical system can be easily reduced.

According to an embodiment, the focal length of the optical system (or the lens group LS, the light guide LG, and the side lenses FL1, FL2, and FL3 may be in a range of 4 mm to 10 mm. The maximum distance or the TTL from the first lens L1 to the first light source 232a may be in a range of 8 mm to 20 mm.

In addition, the first surface of the first lens L1 may have a positive radius of curvature. The second side S12 may have a positive or negative radius of curvature. The third surface S21 of the second lens L2 may have a positive radius of curvature. In addition, the fourth surface S22 of the second lens L2 may have a positive radius of curvature.

The fifth surface S31 of the third lens L3 may have a positive radius of curvature. Furthermore, the sixth surface S32 of the third lens L3 may have a positive or negative radius of curvature.

In particular, as described above, the first surface S11 or an object side surface of the first lens L1 may be convex toward the object side. That is, the first surface S11 may be convex toward the object side, the target side, or the projection side. Due to such a configuration, the TTL can be minimized, and the brightness of light provided to the waveguide WG can be easily secured.

In addition, a size of the light guide LG may be greater than a size of the light source. For example, an area S1 of each side of the light guide LG may be greater than an area of each of the light sources 232a to 232c. For example, an area of each surface of the light guide LG facing each of the light sources 232a to 232c may be greater than the area of each of the light sources 232a to 232c facing the light guide LG. For example, an area of the first side LGS1 of the light guide LG is greater than an area of the first light source 232a. An area of the second side LGS2 of the light guide is greater than an area of the second light source 232b. An area of the third side LGS3 of the light guide is greater than an area of the third light source 232c. The minimum length or minimum directional length of the light guide LG may be greater than the minimum length or minimum directional length of each light source (the first light source). For example, the minimum length in one direction of the light guide LG may be greater than the minimum length of the light source in one direction. For example, the minimum length of the first side LGS1 of the light guide in one direction is greater than the minimum length of the first light source 232a in one direction. The minimum length of the second side LGS2 of the light guide in one direction is greater than the minimum length of the second light source 232b in one direction. The minimum length of the third side LGS3 of the light guide in one direction is greater than the minimum length of the third light source 232c in one direction. Thus, the efficiency of the light source can be improved, and flare occurrence can be suppressed.

A size or area S1 of each side of the light guide LG may be greater than a size S2 of each side lens in contact with each side. For example, the size S2 of the first side lens FL1 may be smaller than the size S1 of the first side LGS1 of the light guide. For example, a size or effective diameter of the surface FL11 of the first side lens FL1 adjacent to the light guide is smaller than a size of the first side surface LGS1 of the light guide. A size or effective diameter of the surface FL21 of the second side lens FL2 adjacent to the light guide is smaller than a size of the second side LGS2 of the light guide. A size or effective diameter of a surface FL31 of the third side lens FL3 adjacent to the light guide is smaller than a size of the third side LGS3 of the light guide. For example, the minimum length of the light guide LG in one direction is greater than the minimum length of the first to third side lenses in one direction. For example, the minimum length of the first side LGS1 of the light guide in one direction is greater than the minimum length or diameter length of the surface FL11 of the first side lens FL1, which is adjacent to the light guide, in one direction. The minimum length of the second side LGS2 of the light guide in one direction is greater than the minimum length or diameter length of the surface FL12 of the second side lens FL2, which is adjacent to the light guide, in one direction. The minimum length of the third side LGS3 of the light guide in one direction is greater than the minimum length or diameter length of a surface FL13 of the third side lens FL3, which is adjacent to the light guide, in one direction. Due to such a configuration, interference between the side lens FL and the light guide LG can be removed, and ease of manufacturing the side lens can be ensured.

In addition, a size or effective diameter of the light guide LG may be greater than a size or effective diameter of at least one lens among the first to N^{th} lenses Ln (or the fourth lens) of the lens group LS. Due to such a configuration, a decrease in TTL can be secured, and project miniaturization can be achieved.

In addition, a size S4 of the N^{th} lens or fourth lens L4 may be different from a size S3 of the fourth side LGS4 of the light guide LG. For example, the size S4 of the N^{th} lens or fourth lens L4 may be smaller than the size S3 of the fourth side LGS4 of the light guide LG. Accordingly, the miniaturization described above can be achieved.

As a modified example, the size S4 of the N^{th} lens or fourth lens L4 may be smaller than the size S3 of the fourth side LGS4 of the light guide LG. Alternatively, some areas of the fourth lens L4 may be misaligned with the fourth side LGS4 of the light guide LG in the second direction (Y-axis direction).

Furthermore, an object side surface F11 of the first side lens FL1 may be in contact with the first side LGS1 of the light guide LG. An object side surface F21 of the second side lens FL2 may be in contact with the second side LGS2 of the light guide LG. An object side surface F31 of the third side lens FL3 may be in contact with the third side LGS3 of the light guide LG. In addition, an upper surface or the eighth surface S42 of the N^{th} lens or fourth lens L4 may be in contact with the fourth side LGS4 of the light guide LG.

Further, in an embodiment, the refractive power or power of the first lens L1 may be positive. The combined power of the lenses positioned between the first lens L1 and the N^{th} lens Ln may be positive or negative. That is, the combined power of the second lens L2 and the third lens L3 may be positive or negative.

The second lens L2 may have positive or negative refractive power. The third lens may have negative or positive refractive power. The side lenses FL1 to FL3 may have positive refractive power.

As described above, each side lens may have a radius of curvature of 100 mm or more on the optical axis of surfaces or joining surfaces FL11, FL21, and FL31 adjacent to the light guide LG. The optical axis may correspond to a central axis of light emitted to the light guide through each light source.

In addition, as described above, each side lens may be coupled to the light guide LG by a contact member or a joining member. The joining member may be made of a transparent material and may have a refractive index that is similar to that of the light guide LG or the side lens. That is, the joining member may be positioned between the light guide LG and one of the first to third side lenses FL1 to FL3. In addition, the joining member may be positioned between the light guide LG and the fourth lens L4.

As described above, a size or length of a side surface of the light guide LG may be greater than or equal to that of a surface of each side lens adjacent to the light guide LG. In this case, even when the size of the side surface of the light guide LG is different from that of the joining surface FL11, FL21, or FL31 of each side lens adjacent to the light guide, a length in one direction (first direction, second direction, or third direction) is greater than or equal to that of the joining surface FL11, FL21, or FL31 of each side lens adjacent to the light guide. For example, a length of the side surface of the light guide LG in one direction (first direction, second direction, or third direction) is greater than a length of each of the side lenses (first to third side lenses) in one direction (first direction, second direction, or third direction). For example, lengths of the side surface of the light guide LG in two directions may be greater than lengths of a junction of each side in two directions. In addition, the side surface of the light guide LG in one direction is longer than the length of the joining surface of the lens in one direction.

As a modified example, the length of the side surface of the light guide LG in one direction (first direction, second direction, or third direction) is shorter than the length of each of the side lenses (first to third side lenses) in one direction (first direction, second direction, or third direction). For example, the lengths of the side surface of the light guide LG in two directions may be greater than the length of the junction of each side surface in two directions, and a length of the side surface of the light guide LG in the one remaining direction may be shorter than the length of the junction of the lens in one direction.

In addition, in an embodiment, the joining surface F11, F21, F31, or S42 of each side surface adjacent to the light guide LG may be a planar surface. For example, the surface adjacent to the light guide LG or the joining surface F11 of the first side lens FL1 may be a surface that is perpendicular to the first direction.

Furthermore, the “semi-aperture” may have a radius of an effective aperture or a radius of a light range.

As described above, the waveguide WG may be disposed to face the first lens L1. That is, the waveguide WG may be positioned adjacent to the first lens L1. The aperture ST may be positioned in a direction from the first lens L1 to the waveguide. The aperture ST may be positioned adjacent to the first lens L1. The aperture ST may be positioned to correspond to a contact point between the projection device and the waveguide WG.

In addition, in an embodiment, in at least one of the N lenses, a surface (object side surface) opposite to a surface facing the light guide may be concave toward the light guide LG.

A length of the N lenses in the second direction (Y-axis direction) may be shorter than a length of the light guide LG in the second direction.

Furthermore, content of Table 1 below may be applied to each component of the optical system according to the embodiment.

TABLE 1

| [symbol] | Aperture [symbol] | First lens [symbol] | Second lens [symbol] | Third lens [symbol] | Fourth lens [symbol] |
|---|---|---|---|---|---|
| [symbol] | [symbol] | [symbol] | 0.22459067 [symbol] | −0.341613897 | 0.071944817 [symbol] |

| [symbol] | 2.290491544 [symbol] | [symbol] | 1.943472078 [symbol] | 1.839 [symbol] | 1.5 [symbol] | 1.5 [symbol] | 1.295464 [symbol] | 1. [symbol] 48797 [symbol] | 1.4509924 [symbol] |
|---|---|---|---|---|---|---|---|---|---|
| Thickness [symbol] | 1 [symbol] | 1.041 [symbol] | 0.1 [symbol] | 1.11 [symbol] | 9.3 [symbol] | 9.5 [symbol] | 0.659 [symbol] | [symbol] .651 [symbol] | [symbol] .208 [symbol] |
| Glass [symbol] | [symbol] | MPCD4_HOYA [symbol] | AI [symbol] | TAPD [symbol] _HOYA [symbol] | AIR [symbol] | FD [symbol] _HOYA [symbol] | AIR [symbol] | MTAFD307_HOYA [symbol] | AIR [symbol] |
| refractive [symbol] | [symbol] | 1.61806 [symbol] | [symbol] | 1.870705 [symbol] | [symbol] | 1.34665 [symbol] | [symbol] | 1.033023 [symbol] | [symbol] |
| abbe [symbol] | [symbol] | 53.8554 [symbol] | [symbol] | 40.7285 [symbol] | [symbol] | 23.784 [symbol] | [symbol] | 37.231 [symbol] | [symbol] |
| Y Radius [symbol] | [symbol] | 7.206089887 [symbol] | −106.85115 [symbol] | 3.4471932 [symbol] | 23.76324295 [symbol] | 15.85927424 [symbol] | 2.1683065 [symbol] | -6.65023548 [symbol] | -4.607 [symbol] |
| Focal [symbol] | [symbol] | 10. [symbol] | [symbol] | 4.452544637 [symbol] | [symbol] | −2.927381 [symbol] | [symbol] | 13.89954192 [symbol] | [symbol] |
| Conic | [symbol] | 3.58 [symbol] | [symbol] | [symbol] | [symbol] | [symbol] | [symbol] | [symbol] | [symbol] |
| Constant | | | | | | | | | |
| (K) [symbol] | | | | | | | | | |

| [symbol] | Fifth lens [symbol] | | Light guide [symbol] | | Side lens [symbol] | | Filter [symbol] | | [symbol] |
|---|---|---|---|---|---|---|---|---|---|
| [symbol] | [symbol] | | [symbol] | [symbol] | [symbol] | [symbol] | [symbol] | [symbol] | [symbol] |
| [symbol] | 1.4 [symbol] 470119 [symbol] | 1.4785317 [symbol] | 1.476531 [symbol] | 1.5 [symbol] | 1.55461 [symbol] | 1.5664433 [symbol] | 1.574 [symbol] | 1.588426 [symbol] | [symbol] |
| Thickness [symbol] | [symbol] | [symbol] | [symbol] | [symbol] | 0.301 [symbol] | 0.101 [symbol] | 0.50 [symbol] | 0.3 [symbol] | [symbol] |
| Glass [symbol] | BK7_SCHOTT [symbol] | AIR [symbol] | BK7_SCHOTT [symbol] | AIR [symbol] | BK7_SCHOTT [symbol] | AIR [symbol] | AIR [symbol] | BK7_SCHOTT [symbol] | [symbol] |
| refractive [symbol] | 1.5168 [symbol] | [symbol] | 1.5168 [symbol] | [symbol] | 1.5168 [symbol] | [symbol] | [symbol] | 1.5 [symbol] | [symbol] |
| abbe [symbol] | 54.19 [symbol] | [symbol] | 54.19 [symbol] | [symbol] | 54.19 [symbol] | [symbol] | [symbol] | [symbol] | [symbol] |
| Y Radius [symbol] | 1.00E+18 [symbol] | 1.00E+18 [symbol] | 1.00E+18 [symbol] | 1.00E+18 [symbol] | 1.00E+18 [symbol] | 1.00E+18 [symbol] | 1.00E+18 [symbol] | 1.00E+18 [symbol] | [symbol] |
| Focal [symbol] | inf [symbol] | [symbol] | inf [symbol] | [symbol] | inf [symbol] | [symbol] | [symbol] | inf [symbol] | [symbol] |
| Conic | [symbol] | [symbol] | [symbol] | [symbol] | [symbol] | [symbol] | [symbol] | [symbol] | [symbol] |
| Constant | | | | | | | | | |
| (K) [symbol] | | | | | | | | | |

| | | | | | | | | | | | | | | | | | |
|---|---|---|---|---|---|---|---|---|---|---|---|---|---|---|---|---|---|
| 4th Order | [symbol] | 0.004546576 [symbol] | 0.001555562 [symbol] | [symbol] | [symbol] | [symbol] .019696282 [symbol] | − [symbol] .000631473 [symbol] | [symbol] | [symbol] | [symbol] | [symbol] | [symbol] | [symbol] | [symbol] | [symbol] | [symbol] | [symbol] |
| Coefficient | | | | | | | | | | | | | | | | | |
| (A) [symbol] | | | | | | | | | | | | | | | | | |
| 6th Order | [symbol] | −3.43E−04 [symbol] | −0.001734716 [symbol] | [symbol] | [symbol] | −0.004400538 [symbol] | − [symbol] .00518243 [symbol] | [symbol] | [symbol] | [symbol] | [symbol] | [symbol] | [symbol] | [symbol] | [symbol] | [symbol] | [symbol] |
| Coefficient | | | | | | | | | | | | | | | | | |
| (B) [symbol] | | | | | | | | | | | | | | | | | |
| 8th Order | [symbol] | −5.31E−05 [symbol] | 9.79E−05 [symbol] | [symbol] | [symbol] | 3.42E−04 [symbol] | 2.11E−05 [symbol] | [symbol] | [symbol] | [symbol] | [symbol] | [symbol] | [symbol] | [symbol] | [symbol] | [symbol] | [symbol] |
| Coefficient | | | | | | | | | | | | | | | | | |
| (C) [symbol] | | | | | | | | | | | | | | | | | |
| 10th Order | [symbol] | [symbol] 5.69E−07 [symbol] | 0.00E+00 [symbol] | [symbol] | [symbol] | −8.31E−0 [symbol] | −3.95E−07 [symbol] | [symbol] | [symbol] | [symbol] | [symbol] | [symbol] | [symbol] | [symbol] | [symbol] | [symbol] | [symbol] |
| Coefficient | | | | | | | | | | | | | | | | | |
| (D) [symbol] | | | | | | | | | | | | | | | | | |
| 12th Order | [symbol] | [symbol] .00E+00 [symbol] | 3.00E+03 [symbol] | [symbol] | [symbol] | [symbol] .00E−09 [symbol] | 1.00E−09 [symbol] | [symbol] | [symbol] | [symbol] | [symbol] | [symbol] | [symbol] | [symbol] | [symbol] | [symbol] | [symbol] |
| Coefficient | | | | | | | | | | | | | | | | | |
| (E) [symbol] | | | | | | | | | | | | | | | | | |
| 14th Order | [symbol] | 0 [symbol] | 0 [symbol] | [symbol] | [symbol] | 0.00E+00 [symbol] | 0.00E+00 [symbol] | [symbol] | [symbol] | [symbol] | [symbol] | [symbol] | [symbol] | [symbol] | [symbol] | [symbol] | [symbol] |
| Coefficient | | | | | | | | | | | | | | | | | |
| (F) [symbol] | | | | | | | | | | | | | | | | | |
| 16th Order | [symbol] | 0 [symbol] | 0 [symbol] | [symbol] | [symbol] | 0.00E+00 [symbol] | 0.00E+00 [symbol] | [symbol] | [symbol] | [symbol] | [symbol] | [symbol] | [symbol] | [symbol] | [symbol] | [symbol] | [symbol] |
| Coefficient | | | | | | | | | | | | | | | | | |
| (G) [symbol] | | | | | | | | | | | | | | | | | |
| 18th Order | [symbol] | 0 [symbol] | 0 [symbol] | [symbol] | [symbol] | 0.00E+00 [symbol] | 0.00E+00 [symbol] | [symbol] | [symbol] | [symbol] | [symbol] | [symbol] | [symbol] | [symbol] | [symbol] | [symbol] | [symbol] |
| Coefficient | | | | | | | | | | | | | | | | | |
| (H) [symbol] | | | | | | | | | | | | | | | | | |
| 20th Order | [symbol] | 0 [symbol] | 0 [symbol] | [symbol] | [symbol] | 0.00E+00 [symbol] | 0.00E+00 [symbol] | [symbol] | [symbol] | [symbol] | [symbol] | [symbol] | [symbol] | [symbol] | [symbol] | [symbol] | [symbol] |
| Coefficient | | | | | | | | | | | | | | | | | |
| (I) [symbol] | | | | | | | | | | | | | | | | | |

[symbol]

indicates data missing or illegible when filed

Here, the left column of each lens discloses content of surfaces facing the waveguide, and the right column discloses content of surfaces facing the light source. For the side lenses, the left column discloses surfaces of the surfaces F11, F21, and F31 facing the light guide, and the right column discloses the surfaces F12, F22, and F32 facing the light source. A thickness of each lens corresponds to the left column. An interval between adjacent lenses corresponds to the right column. The right column in the thickness indicates an interval with an adjacent member in a direction toward the light source. For example, content of the first surface in the first lens is disclosed in the left column. Content of the second surface in the first lens is disclosed in the right column. Furthermore, a unit of a length such as a thickness may be mm. FIG. 14 is a view of an optical system of a projection device according to a second embodiment.

Referring to FIG. 14, the projection device according to the second embodiment may include the optical system as described above. In particular, as described in the first embodiment, the optical system in the present embodiment may include an aperture ST, a lens group LS, a light guide LG, a side lens FL1, an optical element 233a, and a light source 232a. Except for content to be described below, the content described above may be equally applied.

However, in the present embodiment, one to three light sources may be provided. The optical system may include a first light source, a second light source, a third light source, and a fourth light source. The optical system may include the first optical element 233a and the first side lens FL1. Accordingly, the description of the second optical element, the third optical element, the second side lens, the third side lens, the second light source, and the third light source described above may not be applied to the present embodiment.

In the device, when the light source includes only the first light source, the light source may include light sources having various colors or wavelength bands. The first light source may include an RGB light source, for example, an RGB light-emitting diode (LED). Alternatively, the first light source may include a monochromatic light source (LED) that outputs any one color of R, G, and B. Alternatively, the first light source may include a light source (LED) that outputs two colors of R, G, and B. In this case, content of each component such as the light source may be equally applied to Table 2 below.

Content of Table 2 below may equally applied to each component of the optical system according to the present embodiment.

TABLE 2

| [symbol] | Aperture [symbol] | First lens [symbol] | Second lens [symbol] | Third lens [symbol] | Fourth lens [symbol] |
|---|---|---|---|---|---|
| [symbol] | [symbol] | [symbol] .09 [symbol] | [symbol] .324590674 [symbol] | − [symbol] .341613897 [symbol] | [symbol] .071944817 [symbol] |

| [symbol] | 2.290491544 [symbol] | 2 [symbol] | 1.94 [symbol] | 1.839365062 [symbol] | 1.57 [symbol] | 1.5 [symbol] | 1.295464529 [symbol] | 1.13348797 [symbol] | 1.4509924 [symbol] |
|---|---|---|---|---|---|---|---|---|---|
| Thickness [symbol] | 1 [symbol] | 1.041 [symbol] | 0.1 [symbol] | 1. [symbol] | [symbol] | 0.5 [symbol] | [symbol] | 0.655 [symbol] | 0.208 [symbol] |
| Glass [symbol] | [symbol] | MPCD4_HOYA [symbol] | AI [symbol] | TAFD32_HOYA [symbol] | AIR [symbol] | FDS99_HOYA [symbol] | AIR [symbol] | MEAFD307_HOYA [symbol] | AIR [symbol] |
| refractive [symbol] | [symbol] | 1.61806 [symbol] | [symbol] | 1.870795 [symbol] | [symbol] | 1.84666 [symbol] | [symbol] | 1. [symbol] | [symbol] |
| abbe [symbol] | [symbol] | [symbol] 3.8554 [symbol] | [symbol] | 4 [symbol] .728 [symbol] | [symbol] | 23.7848 [symbol] | [symbol] | 37.2313 [symbol] | [symbol] |
| Y Radius [symbol] | [symbol] | 7. [symbol] | −1 [symbol] .58713 [symbol] | 3.447193248 [symbol] | 22.76 [symbol] 4295 [symbol] | 15.85937424 [symbol] | 2.16820659 [symbol] | −6.650305488 [symbol] | −4.6077 [symbol] |
| Focal [symbol] | [symbol] | 10.6778 [symbol] | [symbol] | 4.452 [symbol] 44 [symbol] | [symbol] | −2.92728138 [symbol] | [symbol] | 13.8995419 [symbol] | [symbol] |
| Conic | [symbol] | [symbol] | [symbol] | [symbol] | [symbol] | [symbol] | [symbol] | [symbol] | [symbol] |
| Constant | | | | | | | | | |
| (K) [symbol] | | | | | | | | | |
| 4th Order | [symbol] | −0.002034228 [symbol] | [symbol] | [symbol] | [symbol] | [symbol] | [symbol] | [symbol] | 1.43E− [symbol] |
| Coefficient | | | | | | | | | |
| (A) [symbol] | | | | | | | | | |
| 6th Order | [symbol] | − [symbol] E−05 [symbol] | [symbol] | [symbol] | [symbol] | [symbol] | [symbol] | [symbol] | −6.55E−05 [symbol] |
| Coefficient | | | | | | | | | |
| (B) [symbol] | | | | | | | | | |
| 8th Order | [symbol] | − [symbol] E−05 [symbol] | [symbol] | [symbol] | [symbol] | [symbol] | [symbol] | [symbol] | −3.57E− [symbol] |
| Coefficient | | | | | | | | | |
| (C) [symbol] | | | | | | | | | |
| 10th Order | [symbol] | [symbol] | [symbol] | [symbol] | [symbol] | [symbol] | [symbol] | [symbol] | [symbol] |
| Coefficient | | | | | | | | | |
| (D) [symbol] | | | | | | | | | |
| 12th Order | [symbol] | [symbol] | [symbol] | [symbol] | [symbol] | [symbol] | [symbol] | [symbol] | [symbol] |
| Coefficient | | | | | | | | | |
| (E) [symbol] | | | | | | | | | |
| 14th Order | [symbol] | [symbol] | [symbol] | [symbol] | [symbol] | [symbol] | [symbol] | [symbol] | [symbol] |
| Coefficient | | | | | | | | | |
| (F) [symbol] | | | | | | | | | |
| 16th Order | [symbol] | [symbol] | [symbol] | [symbol] | [symbol] | [symbol] | [symbol] | [symbol] | [symbol] |
| Coefficient | | | | | | | | | |
| (G) [symbol] | | | | | | | | | |
| 18th Order | [symbol] | [symbol] | [symbol] | [symbol] | [symbol] | [symbol] | [symbol] | [symbol] | [symbol] |
| Coefficient | | | | | | | | | |
| (H) [symbol] | | | | | | | | | |
| 20th Order | [symbol] | [symbol] | [symbol] | [symbol] | [symbol] | [symbol] | [symbol] | [symbol] | [symbol] |
| Coefficient | | | | | | | | | |
| (J) [symbol] | | | | | | | | | |

| [symbol] | Fifth lens [symbol] | | Light guide [symbol] | | Side lens [symbol] | | Filter [symbol] | | [symbol] |
|---|---|---|---|---|---|---|---|---|---|
| [symbol] | [symbol] | | [symbol] | [symbol] | [symbol] | [symbol] | [symbol] | [symbol] | [symbol] |
| [symbol] | 1.45470119 [symbol] | 1.4785317 [symbol] | 1.476531671 [symbol] | 1.5546128 [symbol] | 1.554612825 [symbol] | 1.5664427 [symbol] | 1.5746153 [symbol] | 1.528426437 [symbol] | [symbol] |
| Thickness [symbol] | [symbol] | [symbol] | 3.2 [symbol] | [symbol] | [symbol] | 0. [symbol] | 0.50872 [symbol] | 0. [symbol] | [symbol] |
| Glass [symbol] | BK7_SCHOTT [symbol] | AIR [symbol] | BK7_SCHOTT [symbol] | AIR [symbol] | BK7_SCHOTT [symbol] | AIR [symbol] | AIR [symbol] | BK7_SCHOTT [symbol] | [symbol] |
| refractive [symbol] | 1.5168 [symbol] | [symbol] | 1.5168 [symbol] | [symbol] | 1.5168 [symbol] | [symbol] | [symbol] | 1.5168 [symbol] | [symbol] |
| abbe [symbol] | [symbol] 4.1987 [symbol] | [symbol] | [symbol] 4.1987 [symbol] | [symbol] | [symbol] 4.1987 [symbol] | [symbol] | [symbol] | [symbol] 4.1987 [symbol] | [symbol] |
| Y Radius [symbol] | 1.00E+18 [symbol] | 1.00E+18 [symbol] | 1.00E+18 [symbol] | 1.00E+18 [symbol] | 1.00E+18 [symbol] | 1.00E+18 [symbol] | 1.00E+18 [symbol] | 1.00E+18 [symbol] | [symbol] |
| Focal [symbol] | inf [symbol] | [symbol] | inf [symbol] | [symbol] | inf [symbol] | [symbol] | [symbol] | inf [symbol] | [symbol] |
| Conic | [symbol] | [symbol] | [symbol] | [symbol] | [symbol] | [symbol] | [symbol] | [symbol] | [symbol] |
| Constant | | | | | | | | | |
| (K) [symbol] | | | | | | | | | |
| 4th Order | [symbol] | [symbol] | [symbol] | [symbol] | [symbol] | [symbol] | [symbol] | [symbol] | [symbol] |
| Coefficient | | | | | | | | | |
| (A) [symbol] | | | | | | | | | |
| 6th Order | [symbol] | [symbol] | [symbol] | [symbol] | [symbol] | [symbol] | [symbol] | [symbol] | [symbol] |
| Coefficient | | | | | | | | | |
| (B) [symbol] | | | | | | | | | |
| 8th Order | [symbol] | [symbol] | [symbol] | [symbol] | [symbol] | [symbol] | [symbol] | [symbol] | [symbol] |
| Coefficient | | | | | | | | | |
| (C) [symbol] | | | | | | | | | |
| 10th Order | [symbol] | [symbol] | [symbol] | [symbol] | [symbol] | [symbol] | [symbol] | [symbol] | [symbol] |
| Coefficient | | | | | | | | | |
| (D) [symbol] | | | | | | | | | |
| 12th Order | [symbol] | [symbol] | [symbol] | [symbol] | [symbol] | [symbol] | [symbol] | [symbol] | [symbol] |
| Coefficient | | | | | | | | | |
| (E) [symbol] | | | | | | | | | |
| 14th Order | [symbol] | [symbol] | [symbol] | [symbol] | [symbol] | [symbol] | [symbol] | [symbol] | [symbol] |
| Coefficient | | | | | | | | | |
| (F) [symbol] | | | | | | | | | |
| 16th Order | [symbol] | [symbol] | [symbol] | [symbol] | [symbol] | [symbol] | [symbol] | [symbol] | [symbol] |
| Coefficient | | | | | | | | | |
| (G) [symbol] | | | | | | | | | |
| 18th Order | [symbol] | [symbol] | [symbol] | [symbol] | [symbol] | [symbol] | [symbol] | [symbol] | [symbol] |
| Coefficient | | | | | | | | | |
| (H) [symbol] | | | | | | | | | |
| 20th Order | [symbol] | [symbol] | [symbol] | [symbol] | [symbol] | [symbol] | [symbol] | [symbol] | [symbol] |
| Coefficient | | | | | | | | | |
| (J) [symbol] | | | | | | | | | |

[symbol]

indicates data missing or illegible when filed

Here, the left column of each lens discloses content of surfaces facing a waveguide, and the right column discloses content of surfaces facing the light source. For the side lenses, the left column discloses content of surfaces F11, F21, and F31 facing the light guide, and the right column discloses the content of surfaces F12, F22, and F32 facing the light source. A thickness of each lens corresponds to the left column. An interval between adjacent lenses corresponds to the right column. For example, content of a first surface in a first lens is disclosed in the left column. Content of a second surface in the first lens is disclosed in the right column. Furthermore, for the light guide (side lens or optical element), the left column discloses content of surfaces facing the waveguide. For the light guide (side lens or optical elements), the right column discloses content of surfaces facing each light source (for example, a second side lens facing a second light source). Furthermore, for a thickness of the light guide (side lens or optical member), the left column discloses a thickness of a corresponding component (length in a first direction or along an optical axis), and the right column discloses a separation distance in the first direction between a corresponding component and a component closest to the light source. These descriptions may be equally applied to those in Table 1.

1. A projection device comprising:
a light guide;
a first light source disposed at a first side of the light guide;
a lens group disposed at a fourth side of the light guide; and
a first side lens disposed between the first side of the light guide and the first light source,
wherein the lens group includes first to N^{th} lenses sequentially disposed in an optical axis direction of the lens group,
the first lens is positioned farthest from the fourth side of the light guide, and
the first lens and an N−1 lens are aspherical.

2. The projection device of claim 1, comprising:
a second light source disposed at a second side of the light guide;
a third light source disposed at a third side of the light guide;
a second side lens disposed between the second side of the light guide and the second light source; and
a third side lens disposed between the third side of the light guide and the third light source.

3. The projection device of claim 2, wherein the second side and the third side face each other, and
the first side and the fourth side face each other.

4. The projection device of claim 2, wherein the first side lens, the second side lens, the third side lens, and the N^{th} lens are in contact with the light guide.

5. The projection device of claim 2, wherein at least one surface of each of the first side lens, the second side lens, the third side lens, and the N^{th} lens is flat.

6. The projection device of claim 1, wherein a projection side surface or an image side surface of the first lens is convex toward a projection side.

7. The projection device of claim 2, wherein optical axes of the first side lens, the second side lens, the third side lens, and the N^{th} lens are orthogonal to each other.

8. The projection device of claim 1, wherein a total track length (TTL) from the first lens to the light source is smaller than or equal to twice a focal length of an optical system including the lens group, the light guide, and the first side lens.

9. The projection device of claim 1, wherein a minimum length of the light guide is greater than a minimum length of the first light source.

10. The projection device of claim 2, wherein the first side of the light guide overlaps the fourth side of the light guide in the optical axis direction of the lens group.

11. The projection device of claim 1, further comprising a filter disposed between the first side lens and the first light source.

12. The projection device of claim 1, wherein the N−1-th lens is a second-closest lens to the fourth side of the light guide within the lens group.

13. The projection device of claim 1, wherein an image side surface of the first lens is convex.

14. The projection device of claim 2, wherein image-side surfaces of the first, second, and third side lenses are concave toward image side.

15. The projection device of claim 1, wherein the first lens includes a first surface facing a waveguide and a second surface facing the light guide.

16. The projection device of claim 15, wherein the first surface has a positive radius of curvature.

17. The projection device of claim 2, wherein a minimum length of the light guide in one direction is greater than a minimum length in the same direction of the first side lens to third side lens.

18. The projection device of claim 17, wherein a minimum length of the first side of the light guide in one direction is greater than a minimum length in the same direction of a surface of the first side lens adjacent to the light guide.

19. The projection device of claim 15, wherein the first surface and the second surface have radius of curvature with opposite signs.

20. The projection device of claim 1, wherein the first side lens, second side lens, and third side lens and the N-th lens each have a radius of curvature of 10 or more at a projection side with respect to the light guide.
